(19) United States
(12) Patent Application Publication
(10) Pub. No.: US 2021/0040680 A1
(43) Pub. Date: Feb. 11, 2021

(54) FLAME-RETARDED COMPLEX FIBERS AND PROCESSES FOR PREPARING THEM

(71) Applicant: NIPPON PAPER INDUSTRIES CO., LTD., Tokyo (JP)

(72) Inventors: Hiroto Matsumoto, Tokyo (JP); Moe Fuchise, Tokyo (JP); Dai Nagahara, Tokyo (JP)

(21) Appl. No.: 16/964,596

(22) PCT Filed: Feb. 13, 2019
(86) PCT No.: PCT/JP2019/005024

§ 371 Date: Jul. 24, 2020

(30) Foreign Application Priority Data
Feb. 13, 2018 (JP) 2018-023581

(51) Int. Cl. D06M 11/77; D06M 11/80; D06M 11/58; D06M 11/68

(52) U.S. Cl. CPC D06M 11/77; D06M 11/80; D06M 2101/06; D06M 11/68; D06M 2200/30; D06M 11/58

(57) ABSTRACT

The present invention aims to provide complex fibers of inorganic particles and a fiber exhibiting high flame retardancy. According to the present invention, complex fibers of inorganic particles and a fiber treated with a flame retardant are provided. In the complex fibers of the present invention, 15% or more of the surface of the fiber is covered by the inorganic particles.

### TECHNICAL FIELD

The present invention relates to flame-retarded complex fibers and processes for preparing them. In particular, the present invention relates to flame-retarded complex fibers composed of inorganic particles and a fiber as well as processes for preparing them.

### BACKGROUND ART

Techniques for improving the flame retardancy of materials have been proposed in various fields. For example, woody materials such as wood or natural fibers are relatively easy to burn, and therefore attempts have been made to make them hard to burn by treating them with a chemical such as a flame retardant (PTLs 1 to 2).

On the other hand, fibers such as woody fibers have various properties based on the functional groups or the like on their surface, but sometimes need to be surface-modified depending on the purposes, and therefore techniques for modifying the surface of fibers have already been developed. For example, a technique for precipitating inorganic particles on a fiber such as a cellulose fiber is disclosed in PTL 3, which describes a complex comprising crystalline calcium carbonate mechanically bonded on a fiber. Further, PTL 4 describes a technique for preparing a complex of a pulp and calcium carbonate by precipitating calcium carbonate in a suspension of the pulp by the carbonation process.

### CITATION LIST

### Patent Literature

PTL 1: JPA 1996-73212

PTL 2: JPA 2003-291110

PTL 3: JPA 1994-158585

PTL 4: US Patent No. 5679220

### SUMMARY OF INVENTION

### Technical Problem

However, fibers conventionally treated with a flame retardant or the like tended to be stiff and brittle so that their characteristic flexibility was sometimes compromised. Further, it was difficult to perform printing on fibers treated with a fire retardant, e.g., it was difficult to perform processing such as printing on fire-retarded fiber sheets so that they were sometimes limited in their applications.

Under such circumstances, the present invention aims to provide flame-retarded materials retaining the flexibility of fibers while attaining high printability.

### Solution To Problem

As a result of careful studies to solve the problems described above, we found that the problems described above can be solved by using a complex of inorganic particles and a fiber (complex fiber) instead of paper as a substrate, and thus accomplished the present invention. The present invention includes, but not limited to, the following:
(1) A complex fiber of inorganic particles and a fiber treated with a flame retardant, wherein 15% or more of the surface of the fiber is covered by the inorganic particles.
(2) The complex fiber of (1), wherein the flame retardant is a boron-based flame retardant or a silicon-based flame retardant.
(3) The complex fiber of (1) or (2), wherein the fiber is a cellulose fiber.
(4) The complex fiber of (1) or (2), wherein the inorganic particles are inorganic particles of at least one member selected from the group consisting of barium sulfate, magnesium carbonate and hydrotalcite.
(5) The complex fiber of any one of (1) to (4), wherein the inorganic particles have an average primary particle size of 1.5 μm or less.
(6) The complex fiber of any one of (1) to (5), wherein the weight ratio between the fiber and the inorganic particles is 5/95 to 95/5.
(7) The complex fiber of any one of (1) to (6), which is in the form of a sheet, molding, board or block.
(8) The complex fiber of any one of (1) to (7), wherein the flame retardant is a phosphorus-based chemical and/or a nitrogen-based chemical.
(9) The complex fiber of any one of (1) to (8), wherein the inorganic particles comprise calcium carbonate or silica/alumina.
(10) A process for preparing the complex fiber of any one of (1) to (9), comprising treating a complex fiber of inorganic particles and a fiber with a flame retardant.
(11) The process of (10), comprising treating the complex fiber by impregnating, coating or spraying it with a flame retardant.
(12) The process of (10), comprising synthesizing the inorganic particles in a solution containing the fiber to give the complex fiber.

### Advantageous Effects of Invention

According to the present invention, especially excellent flame-retarded sheets can be obtained by using a composite material comprising a fiber covered by inorganic particles on its surface so that each fiber filament is protected against burning by the inorganic particles. The sheets formed from the complex fiber of the present invention can retain flexibility because the inorganic particles also exist at high density in addition to the fiber so that the inorganic particles intervene between fiber filaments that would have been stiff and brittle by the flame retardant. Further, complex fiber sheets having high printing quality can be obtained because the worsening of ink bleeding or color reproduction by chemical treatment can be reduced when the complex fiber sheets are used as substrates for inkjet printing.

### BRIEF DESCRIPTION OF DRAWINGS

FIG. 1 is a schematic diagram showing a reaction system used in the experiments.

FIG. 2 is a schematic diagram showing a reaction system used in the experiments.

FIG. 3 shows electron micrographs of a complex (Sample 1) used in the experiments (magnification: left 3000×, right 50000×).

FIG. 4 shows electron micrographs of a complex (Sample 2) used in the experiments (magnification: left 3000×, right 10000×).

FIG. 5 shows electron micrographs of a complex (Sample 3) used in the experiments (magnification: left 3000×, right 50000×).

FIG. 6 shows electron micrographs of a complex (Sample 4) used in the experiments (magnification: left 3000×, right 50000×).

FIG. 7 shows electron micrographs of a complex (Sample 5) used in the experiments (magnification: left 3000×, right 50000×).

FIG. 8 is a schematic diagram showing a system used for the synthesis of Sample 6.

FIG. 9 is a schematic diagram showing a system used for the synthesis of Sample 6 (an ultrafine bubble generator).

FIG. 10 shows electron micrographs of a complex (Sample 6) used in the experiments (magnification: left 3000×, right 50000×).

FIG. 11 shows a photograph demonstrating how a flammability test took place in Experiment 3.

FIG. 12 shows a photograph demonstrating how a flammability test took place in Experiment 3.

FIG. 13 shows photographs demonstrating the results of a flammability test in Experiment 3.

FIG. 14 shows photographs demonstrating the results of a flammability test in Experiment 3.

FIG. 15 shows photographs demonstrating the results of a flammability test in Experiment 3.

FIG. 16 shows photographs demonstrating the results of a flammability test in Experiment 3.

### DESCRIPTION OF EMBODIMENTS

The present invention relates to complex fibers (complexes) treated with a flame retardant. According to the present invention, fiber products exhibiting high printability even after treatment with a flame retardant can be obtained by using a complex fiber comprising inorganic particles adhered to a fiber as a substrate.

Flame Retardants

As used herein, the term “flame retardant” refers to the property of a material that is hard to burn; the term “flame retardation” refers to a treatment that makes a material hard to burn; and the term “flame-retardant composition (also referred to as “flame retardant” or “flame retarding agent”)” refers to an additive for making a material hard to burn. With respect to some materials and uses thereof, regulations have been established to standardize detailed criteria and evaluation methods on “flame retardant”. These regulations use such terms as “incombustible” meaning incapable of burning with flame, “flame resistant” meaning capable of preventing spread of fire, “fire-protective” and “fire-resistant” and the like, and as used herein, the term “flame retardant” is defined to include all of these terms.

Flame retardants, also known as fire-retardants, are chemicals that improve the property of a material that is hard to burn. In the present invention, complex fibers are treated with a flame retardant. Flame retardants used include, but are not specifically limited to, boron-based flame retardants containing boron atoms such as boric acid or salts thereof, polyborates, zinc borate and the like, for example. Silicon-based flame retardants containing silicon atoms such as silicates and silicone can also be conveniently used. Other examples include nitrogen-based flame retardants containing nitrogen atoms such as guanidine or a salt thereof, ammonium sulfate, melamine sulfate, and the like; phosphorus-based flame retardants containing phosphorus atoms such as phosphoric acid or a salt thereof, polyphosphates, diethyl ethylphosphonate, dimethyl(methacryloyloxyethyl) phosphate, diethyl-2-(acryloyloxy)ethyl phosphate, triethyl phosphate, diethyl-2-(methacryloylethyl) phosphate, triphenyl phosphate, tricresyl phosphate, phosphate esters, red phosphorus and the like; compounds containing both phosphorus and nitrogen atoms (such as melamine phosphate, guanidine phosphate, guanylurea phosphate, melamine metaphosphate, melamine polyphosphate, melamine-coated ammonium polyphosphate); halogen-containing amino-based acid salts such as guanidine hydrochloride, guanidine hydrobromide and the like; bromine-based flame retardants such as decabromodiphenyl ether, tetrabromobisphenol A, hexabromocyclododecane, ethylene bis(tetrabromophthalimide), bis(pentabromophenyl) ethane, hexabromobenzene and the like; flame retardants formed of a compound containing two or more of the elements shown above including ammonium salts such as ammonium phosphate, ammonium sulfate, ammonium borate, ammonium sulfamate, ammonium chloride, ammonium polyphosphate and the like; as well as inorganic flame retardants including metal hydrate compounds such as aluminum hydroxide hydrate, magnesium hydroxide hydrate, hydrotalcite and the like; antimony-containing compounds such as antimony trioxide, antimony tetroxide, antimony pentoxide and the like; tin compounds such as zinc hydroxystannate, zinc stannate and the like; and metal compounds used for common pigments such as titanium oxide.

Among the flame retardants listed above, chemicals containing boron atoms (boron-based flame retardants) and chemicals containing silicon atoms (silicon-based flame retardants), or chemicals containing phosphorus atoms (phosphorus-based flame retardants) and chemicals containing nitrogen atoms (nitrogen-based flame retardants) are preferred for flame retardation treatment of various materials because of low emission of toxic gas during burning and low environmental loads. Moreover, boron-based flame retardants and silicon-based flame retardants are known to be compatible with sugar compounds such as cellulose. This is because hydroxyl groups are dehydrated at high temperatures during burning to release water, which produces a cooling effect, and a char layer is generated to form a thermal insulating film, as described in JPA 2006-233006.

The flame retardants may be used as a combination of different flame retardants or may be combined with flame retardant aids or the like, and the amount used may be adjusted depending on a desired performance. They can be used in an amount in the range of, for example, 1 to 50%, preferably 5 to 45%, more preferably 10 to 40% based on the weight of the substrate. If the amount is 1% or less, it will be difficult to confer sufficient flame retardancy, but it is not suitable to use 50% or more, because costs will increase.

These flame retardants can be applied by, for example, impregnation, application or spraying using a conventional impregnation or application (coating) technique in cases where they are liquid. For example, the flame retardants can be applied by using a coater such as a forward roll coater, air knife coater, blade coater, Bill blade coater, two stream coater, twin blade coater, rod coater (bar coater), gate roll coater, reverse roll coater, gravure roll coater, notched bar coater, die coater, bead coater, curtain coater, dip coater, electrostatic coater, spray coater or the like.

The timing of the flame retardation treatment may be before, during or after forming a sheet, molding, board, block or the like. If the treatment takes place before or during forming, the process can be shortened, and if the treatment takes place after forming, the content of the flame retardant can be easily controlled.

Complex Fibers Covered by Inorganic Particles on Their Surface

In the present invention, fibers covered by inorganic particles on their surface are used. Particularly in preferred embodiments of the present invention, complexes of a fiber and inorganic particles are used wherein 15% or more of the surface of the fiber is covered by the inorganic particles.

In the complex fibers of the present invention, the inorganic particles rarely drop from the fiber even by disintegration because the fiber and the inorganic particles bind together via hydrogen bonds or the like rather than simply being mixed. The binding strength between a fiber and inorganic particles in a complex can be evaluated by, for example, a value such as ash retention (%, i.e., [(the ash content of a sheet)/(the ash content of the complex before disintegration)]×100). Specifically, a complex is dispersed in water to a solids content of 0.2% and disintegrated in a standard disintegrator as defined by JIS P 8220-1: 2012 for 5 minutes, and then formed into a sheet through a 150-mesh wire according to JIS P 8222: 2015, and the ash retention of the sheet thus prepared can be used for the evaluation, wherein the ash retention is 20% by mass or more in a preferred embodiment, and the ash retention is 50% by mass or more in a more preferred embodiment.

Inorganic Particles

In the present invention, the inorganic particles to be complexed with a fiber are not specifically limited, but preferably insoluble or slightly soluble in water. The inorganic particles are preferably insoluble or slightly soluble in water because the inorganic particles are sometimes synthesized in an aqueous system or the fiber complexes are sometimes used in an aqueous system.

As used herein, the term “inorganic particles” refers to a metal or metal compound. Further, the metal compound refers to the so-called inorganic salt formed by an ionic bond between a metal cation (e.g., Na⁺, Ca²⁺, Mg²⁺, Al³⁺, Ba²⁺ or the like) and an anion (e.g., O²⁻, OH⁻, CO₃²⁻, PO₄³⁻, SO₄²⁻, NO₃⁻, Si₂O₃²⁻, SiO₃²⁻, Cl⁻, F⁻, S²⁻ or the like). In the present invention, the inorganic particles are preferably at least partially a metal salt of calcium, magnesium or barium, or the inorganic particles are preferably at least partially a silicate, or a metal salt of aluminum, or metal particles including titanium, copper, silver, iron, manganese or zinc.

These inorganic particles can be synthesized by a known method, which may be either a gas-liquid or liquid-liquid method. An example of gas-liquid methods is the carbonation process, according to which magnesium carbonate can be synthesized by reacting magnesium hydroxide and carbonic acid gas, for example. Examples of liquid-liquid methods include the reaction between an acid (e.g., hydrochloric acid, sulfuric acid or the like) and a base (e.g., sodium hydroxide, potassium hydroxide or the like) by neutralization; the reaction between an inorganic salt and an acid or a base; and the reaction between inorganic salts. For example, barium sulfate can be obtained by reacting barium hydroxide and sulfuric acid, or aluminum hydroxide can be obtained by reacting aluminum sulfate and sodium hydroxide, or composite inorganic particles of calcium and aluminum can be obtained by reacting calcium carbonate and aluminum sulfate. Such syntheses of inorganic particles can be performed in the presence of any metal or metal compound in the reaction solution, in which case the metal or metal compound is efficiently incorporated into the inorganic particles so that it can form a composite with them. For example, composite particles of calcium phosphate and titanium can be obtained by adding phosphoric acid to calcium carbonate to synthesize calcium phosphate in the presence of titanium dioxide in the reaction solution.

As for calcium carbonate, it can be synthesized by, for example, the carbonation process, the soluble salt reaction process, the lime-soda process, the Solvay process or the like, and in preferred embodiments, calcium carbonate is synthesized by the carbonation process.

Typically, the preparation of calcium carbonate by the carbonation process involves using lime as a calcium source to synthesize calcium carbonate via a slaking step in which water is added to quick lime CaO to give slaked lime Ca(OH)₂ and a carbonation step in which carbonic acid gas CO₂ is injected into the slaked lime to give calcium carbonate CaCO₃. During then, the suspension of slaked lime prepared by adding water to quick lime may be passed through a screen to remove less soluble lime particles contained in the suspension. Alternatively, slaked lime may be used directly as a calcium source. For synthesizing calcium carbonate by the carbonation process in the present invention, the carbonation reaction may be performed in the presence of cavitation bubbles.

Typically known reactors for preparing calcium carbonate by the carbonation process (carbonation reactors or carbonators) include gas injection carbonators and mechanically stirred carbonators. In the gas injection carbonators, carbonic acid gas is injected into a carbonation reactor containing a suspension of slaked lime (milk of lime) where the slaked lime is reacted with the carbonic acid gas, but it is difficult to uniformly and precisely control the size of bubbles simply by injecting carbonic acid gas, which imposes limitations in terms of the reaction efficiency. On the other hand, the mechanically stirred carbonators are equipped with a stirrer inside the carbonators and carbonic acid gas is introduced near the stirrer, whereby the carbonic acid gas is dispersed as fine bubbles to improve the efficiency of the reaction between the slaked lime and the carbonic acid gas (“Handbook of Cement, Gypsum and Lime” published by GIHODO SHUPPAN Co., Ltd., 1995, page 495).

If the reaction solution had a high concentration or the carbonation reaction progressed in cases where stirring took place with a stirrer provided inside a carbonation reactor as in the mechanically stirred carbonators, however, the resistance of the reaction solution increased to hinder sufficient stirring so that the carbonation reaction was difficult to exactly control or a considerable load was imposed on the stirrer for sufficient stirring, thus leading to energy disadvantages. Further, a gas injection port is located at a lower site of the carbonator, and blades of the stirrer are provided near the bottom of the carbonator to promote stirring. Less soluble lime screen residues settle quickly and therefore always stay at the bottom, thereby blocking the gas injection port or disturbing the balance of the stirrer. Moreover, conventional methods required not only a carbonator but also a stirrer and equipment for introducing carbonic acid gas into the carbonator, which also incurred much costs of equipment. In the mechanically stirred carbonators, the carbonic acid gas supplied near the stirrer is dispersed as fine bubbles by the stirrer to improve the efficiency of the reaction between the slaked lime and the carbonic acid gas, but the carbonic acid gas could not be dispersed as sufficiently fine bubbles if the concentration of the reaction solution was high or in other cases, and the carbonation reaction was also disadvantageous in that it was sometimes difficult to precisely control the morphology or the like of the produced calcium carbonate. When calcium carbonate is synthesized in the presence of cavitation bubbles, however, the carbonation reaction proceeds efficiently and uniform calcium carbonate microparticles can be prepared. Especially, the use of a jet cavitation allows sufficient stirring without any mechanical stirrer such as blades. In the present invention, previously known reaction vessels can be used, including the gas injection carbonators and the mechanically stirred carbonators as described above without any inconveniences as a matter of course, and these vessels may be combined with a jet cavitation using a nozzle or the like.

When calcium carbonate is synthesized by the carbonation process, the aqueous suspension of slaked lime preferably has a solids content in the order of 0.1 to 40% by weight, more preferably 0.5 to 30% by weight, still more preferably 1 to 20% by weight. If the solids content is low, the reaction efficiency decreases and the production cost increases, but if the solids content is too high, the flowability decreases and the reaction efficiency decreases. When calcium carbonate is synthesized in the presence of cavitation bubbles, the reaction solution and carbonic acid gas can be mixed well even if a suspension (slurry) having a high solids content is used.

The aqueous suspension containing slaked lime that can be used includes those commonly used for the synthesis of calcium carbonate, and can be prepared by, for example, mixing slaked lime with water or by slaking (digesting) quick lime (calcium oxide) with water. The slaking conditions include, but not specifically limited to, a CaO concentration of 0.1% by weight or more, preferably 1% by weight or more, and a temperature of 20 to 100° C., preferably 30 to 100° C., for example. Further, the average residence time in the slaking reactor (slaker) is not specifically limited either, but can be, for example, 5 minutes to 5 hours, and preferably within 2 hours. It should be understood that the slaker may be batch or continuous. It should be noted that, in the present invention, the carbonation reactor (carbonator) and the slaking reactor (slaker) may be provided separately, or one reactor may serve as both carbonation reactor and slaking reactor.

As for magnesium carbonate, it can be synthesized by a known method. For example, basic magnesium carbonate can be synthesized via normal magnesium carbonate from magnesium bicarbonate, which is synthesized from magnesium hydroxide and carbonic acid gas. Magnesium carbonate can be obtained in various forms such as magnesium bicarbonate, normal magnesium carbonate, basic magnesium carbonate and the like depending on the synthesis method, among which basic magnesium carbonate is especially preferred as magnesium carbonate forming part of the complex fibers of the present invention. This is because magnesium bicarbonate is relatively unstable, while normal magnesium carbonate consists of columnar (needle-like) crystals that may be less likely to adhere to fibers. If the chemical reaction is allowed to proceed in the presence of a fiber until basic magnesium carbonate is formed, however, a complex fiber of magnesium carbonate and the fiber can be obtained in which the surface of the fiber is covered in a fish scale-like pattern.

Further in the present invention, the reaction solution in the reaction vessel can be used in circulation. By circulating the reaction solution in this way to increase contacts between the reaction solution and carbonic acid gas, the reaction efficiency increases and desired inorganic particles can be readily obtained.

In the present invention, a gas such as carbon dioxide (carbonic acid gas) is injected into the reaction vessel where it can be mixed with the reaction solution. According to the present invention, the reaction can be performed with good efficiency because carbonic acid gas can be supplied to the reaction solution without any gas feeder such as a fan, blower or the like and the carbonic acid gas is finely dispersed by cavitation bubbles or ultrafine bubbles.

In the present invention, the concentration of carbon dioxide in the gas containing carbon dioxide is not specifically limited, but the concentration of carbon dioxide is preferably higher. Further, the amount of carbonic acid gas introduced into the injector is not limited and can be selected as appropriate, but carbonic acid gas is preferably used at a flow rate of 100 to 10000 L/hr per kg of slaked lime, for example.

The gas containing carbon dioxide of the present invention may be substantially pure carbon dioxide gas or a mixture with another gas. For example, a gas containing an inert gas such as air or nitrogen in addition to carbon dioxide gas can be used as the gas containing carbon dioxide. In addition to carbon dioxide gas (carbonic acid gas), exhaust gases discharged from incinerators, coal-fired boilers, heavy oil-fired boilers and the like in papermaking factories can also be conveniently used as the gas containing carbon dioxide. Alternatively, the carbonation reaction can also be performed using carbon dioxide emitted from the lime calcination process.

As for barium sulfate (BaSO₄), it is a crystalline ionic compound represented by the formula BaSO₄ and composed of barium ions and sulfate ions, and often assumes a plate-like or columnar form and is poorly soluble in water. Pure barium sulfate occurs as colorless crystals, but turns yellowish brown or black gray and translucent when it contains impurities such as iron, manganese, strontium, calcium or the like. It occurs as a natural mineral or can be synthesized by chemical reaction. Especially, synthetic products obtained by chemical reaction are not only used for medical purposes (as radiocontrast agents) but also widely used for paints, plastics, storage batteries and the like by taking advantage of their chemical stability.

In the present invention, complex fibers of barium sulfate and a fiber can be prepared by synthesizing barium sulfate in a solution in the presence of the fiber. For example, possible methods include the reaction between an acid (e.g., sulfuric acid or the like) and a base by neutralization; the reaction between an inorganic salt and an acid or a base; and the reaction between inorganic salts. For example, barium sulfate can be obtained by reacting barium hydroxide and sulfuric acid or aluminum sulfate, or barium sulfate can be precipitated by adding barium chloride into an aqueous solution containing a sulfate.

As for hydrotalcite, it can be synthesized by a known method. For example, hydrotalcite is synthesized via a co-precipitation reaction at controlled temperature, pH and the like by immersing a fiber in an aqueous carbonate solution containing carbonate ions forming interlayers and an alkaline solution (sodium hydroxide or the like) in a reaction vessel, and then adding an acid solution (an aqueous metal salt solution containing divalent metal ions and trivalent metal ions forming host layers). Alternatively, hydrotalcite can also be synthesized via a co-precipitation reaction at controlled temperature, pH and the like by immersing a fiber in an acid solution (an aqueous metal salt solution containing divalent metal ions and trivalent metal ions forming host layers) in a reaction vessel, and then adding dropwise an aqueous carbonate solution containing carbonate ions forming interlayers and an alkaline solution (sodium hydroxide or the like). The reaction typically takes place at ordinary pressure, though a process involving a hydrothermal reaction using an autoclave or the like has also been reported (JPA 1985-6619).

In the present invention, chlorides, sulfides, nitrates and sulfates of magnesium, zinc, barium, calcium, iron, copper, cobalt, nickel, and manganese can be used as sources of divalent metal ions forming host layers. On the other hand, chlorides, sulfides, nitrates and sulfates of aluminum, iron, chromium and gallium can be used as sources of trivalent metal ions forming host layers.

In the present invention, carbonate ions, nitrate ions, chloride ions, sulfate ions, phosphate ions and the like can be used as interlayer anions. Sodium carbonate is used as a source of carbonate ions when they are interlayer anions. However, sodium carbonate can be replaced by a gas containing carbon dioxide (carbonic acid gas) including substantially pure carbon dioxide gas or a mixture with another gas. For example, exhaust gases discharged from incinerators, coal-fired boilers, heavy oil-fired boilers and the like in papermaking factories can be conveniently used as the gas containing carbon dioxide. Alternatively, the carbonation reaction can also be performed using carbon dioxide emitted from the lime calcination process.

As for alumina and/or silica, they can be synthesized by using any one or more of an inorganic acid or an aluminum salt as a starting material of the reaction and adding an alkali silicate. The synthesis can also be accomplished by using an alkali silicate as a starting material and adding any one or more of an inorganic acid or an aluminum salt, but the product adheres to the fiber more efficiently when an inorganic acid and/or aluminum salt is used as a starting material. The complex fibers of silica and/or alumina obtained in the present invention exhibit Si/Al of 4 or more as determined by X-ray fluorescence/X-ray diffraction analysis of the ash remaining after baking in an electric oven at 525° C. for 2 hours. The ratio is preferably 4 to 30, more preferably 4 to 20, still more preferably 4 to 10. Further, no distinct peaks attributed to crystalline materials are detected when the ash is analyzed by X-ray diffraction because silica and/or alumina obtained in the present invention are/is amorphous. Inorganic acids that can be used include, but not specifically limited to, sulfuric acid, hydrochloric acid, nitric acid or the like, for example. Among them, sulfuric acid is especially preferred in terms of cost and handling. Aluminum salts include aluminum sulfate, aluminum chloride, aluminum polychloride, alum, potassium alum and the like, among which aluminum sulfate can be conveniently used. Alkali silicates include sodium silicate or potassium silicate or the like, among which sodium silicate is preferred because of easy availability. The molar ratio of silicate and alkali is not limited, but commercial products having an approximate molar ratio of SiO₂:Na₂O=3 to 3.4:1 commonly distributed as sodium silicate J3 can be conveniently used. In the present invention, water is used for preparing suspensions or for other purposes, in which case not only common tap water, industrial water, groundwater, well water and the like can be used, but also ion-exchanged water, distilled water, ultrapure water, industrial waste water, and the water obtained in the carbonation step can be conveniently used.

As for calcium sulfate, it can be synthesized by a known method. For example, a fiber is immersed in a reaction vessel, whereby calcium sulfate can be synthesized as a salt obtained by a neutralization reaction of sulfuric acid and calcium hydroxide in the system.

As for calcium silicate, it can be synthesized by a known method. For example, it can be obtained via hydrothermal synthesis by adding a calcium source such as calcium oxide or calcium hydroxide and a silica source such as alpha quartz into an autoclave.

The complex fibers of the present invention can be obtained by synthesizing inorganic particles in the presence of a fiber such as a cellulose fiber. This is because the surface of the fiber provides a suitable site where the inorganic particles are precipitated, thus facilitating the synthesis of complex fibers. Processes for preparing the complex fibers may comprise stirring/mixing a solution containing a fiber and precursors of inorganic particles in an open reaction vessel to synthesize a complex fiber or injecting an aqueous suspension containing a fiber and precursors of inorganic particles into a reaction vessel to synthesize a complex fiber. As described herein below, inorganic particles may be synthesized in the presence of cavitation bubbles or ultrafine bubbles generated during the injection of an aqueous suspension of precursors of the inorganic particles into a reaction vessel.

In the present invention, a liquid may be injected under conditions where cavitation bubbles or ultrafine bubbles are generated in a reaction vessel or a liquid may be injected under conditions where cavitation bubbles or ultrafine bubbles are not generated. The reaction vessel is preferably a pressure vessel in either case. As used herein, the term “pressure vessel” refers to a vessel that can withstand a pressure of 0.005 MPa or more. Under conditions where cavitation bubbles are not generated, the pressure in the pressure vessel is preferably 0.005 MPa or more and 0.9 MPa or less expressed in static pressure.

(Cavitation Bubbles)

For synthesizing the complex fibers of the present invention, inorganic particles can be precipitated in the presence of cavitation bubbles. As used herein, the term “cavitation” refers to a physical phenomenon in which bubbles are generated and disappear in the flow of a fluid in a short time due to a pressure difference. The bubbles generated by cavitation (cavitation bubbles) develop from very small “bubble nuclei” of 100 μm or less present in a liquid when the pressure drops below the saturated vapor pressure in the fluid only for a very short time.

In the present invention, cavitation bubbles can be generated in a reaction vessel by a known method. For example, it is possible to generate cavitation bubbles by injecting a fluid under high pressure, or by stirring at high speed in a fluid, or by causing an explosion in a fluid, or by using an ultrasonic vibrator (vibratory cavitation) or the like.

Particularly in the present invention, cavitation bubbles are preferably generated by injecting a fluid under high pressure because the cavitation bubbles are readily generated and controlled. In this embodiment, a liquid to be injected is compressed by using a pump or the like and injected at high speed through a nozzle or the like, whereby cavitation bubbles are generated simultaneously with the expansion of the liquid itself due to a very high shear force and a sudden pressure drop near the nozzle. Fluid jetting allows cavitation bubbles to be generated with high efficiency, whereby the cavitation bubbles have stronger collapse impact. In the present invention, inorganic particles are synthesized in the presence of controlled cavitation bubbles, clearly in contrast to the cavitation bubbles spontaneously occurring in fluid machinery and causing uncontrollable risks.

In the present invention, the reaction solution of a raw material or the like can be directly used as a jet liquid to generate cavitation, or some fluid can be injected into the reaction vessel to generate cavitation bubbles. The fluid forming a liquid jet may be any of a liquid, a gas, or a solid such as powder or pulp or a mixture thereof so far as it is in a flowing state. Moreover, another fluid such as carbonic acid gas can be added as an extra fluid to the fluid described above, if desired. The fluid described above and the extra fluid may be injected as a homogeneous mixture or may be injected separately.

The liquid jet refers to a jet of a liquid or a fluid containing solid particles or a gas dispersed or mixed in a liquid, such as a liquid jet containing a pulp or a slurry of inorganic particles or bubbles. The gas referred to here may contain bubbles generated by cavitation.

The flow rate and pressure are especially important for cavitation because it occurs when a liquid is accelerated and a local pressure drops below the vapor pressure of the liquid. Therefore, the cavitation number a, which is a fundamental dimensionless number expressing a cavitation state, is defined by equation 1 below (“New Edition Cavitation: Basics and Recent Advance”, Written and Edited by Yoji Katoh, Published by Makishoten, 1999).

$$\begin{matrix} [ Formula 1 ] & \\ σ = \frac{p \text{?} - {p}_{v}}{\frac{1}{2} ρ {U}^{2} \text{?}} \\ \text{?} \text{indicates text missing or illegible when filed} & ( 1 )\end{matrix}$$

If the cavitation number here is high, it means that the flow site is in a state where cavitation is less likely to occur. Especially when cavitation is generated through a nozzle or an orifice tube as in the case of a cavitation jet, the cavitation number σ can be rewritten by equation (2) below where p₁ is the pressure upstream of the nozzle, p₂ is the pressure downstream of the nozzle, and pᵥ is the saturated vapor pressure of sample water, and the cavitation number σ can be further approximated as shown by equation (2) below because the pressure difference between p₁, p₂ and pᵥ is significant in a cavitation jet so that p₁>>p₂>>pᵥ (H. Soyama, J. Soc. Mat. Sci. Japan, 47 (4), 381 1998).

$$\begin{matrix} [ Formula 2 ] & \\ σ = \frac{{p}_{2} - {p}_{ν}}{{p}_{1} - {p}_{2}} \text{?} \frac{{p}_{2}}{{p}_{1}} \\ \text{?} \text{indicates text missing or illegible when filed} & ( 2 )\end{matrix}$$

Cavitation conditions in the present invention are as follow: the cavitation number σ defined above is desirably 0.001 or more and 0.5 or less, preferably 0.003 or more and 0.2 or less, especially preferably 0.01 or more and 0.1 or less. If the cavitation number σ is less than 0.001, little benefit is attained because the pressure difference from the surroundings is small when cavitation bubbles collapse, but if it is greater than 0.5, the pressure difference in the flow is too small to generate cavitation.

When cavitation is generated by emitting a jetting liquid through a nozzle or an orifice tube, the pressure of the jetting liquid (upstream pressure) is desirably 0.01 MPa or more and 30 MPa or less, preferably 0.7 MPa or more and 20 MPa or less, more preferably 2 MPa or more and 15 MPa or less. If the upstream pressure is less than 0.01 MPa, little benefit is attained because a pressure difference is less likely to occur from the downstream pressure. If the upstream pressure is higher than 30 MPa, a special pump and pressure vessel are required and energy consumption increases, leading to cost disadvantages. On the other hand, the pressure in the vessel (downstream pressure) is preferably 0.005 MPa or more and 0.9 MPa or less expressed in static pressure. Further, the ratio between the pressure in the vessel and the pressure of the jetting liquid is preferably in the range of 0.001 to 0.5.

In the present invention, inorganic particles can also be synthesized by injecting a jetting liquid under conditions where cavitation bubbles are not generated. Specifically, the pressure of the jetting liquid (upstream pressure) is controlled at 2 MPa or less, preferably 1 MPa or less, while the pressure of the jetting liquid (downstream pressure) is released, more preferably 0.05 MPa or less.

The jet flow rate of the jetting liquid is desirably in the range of 1 m/sec or more and 200 m/sec or less, preferably in the range of 20 m/sec or more and 100 m/sec or less. If the jet flow rate is less than 1 m/sec, little benefit is attained because the pressure drop is too small to generate cavitation. If it is greater than 200 m/sec, however, special equipment is required to generate high pressure, leading to cost disadvantages.

In the present invention, cavitation may be generated in the reaction vessel where inorganic particles are synthesized. The process can be run in one pass, or can be run through a necessary number of cycles. Further, the process can be run in parallel or in series using multiple generating means.

Liquid injection for generating cavitation may take place in a vessel open to the atmosphere, but preferably takes place within a pressure vessel to control the cavitation.

When cavitation is generated by liquid injection, the solids content of the reaction solution is preferably 30% by weight or less, more preferably 20% by weight or less. This is because cavitation bubbles are more likely to homogeneously act on the reaction system at such levels. Further, the solids content of the aqueous suspension of slaked lime forming the reaction solution is preferably 0.1% by weight or more to improve the reaction efficiency.

When a complex of calcium carbonate and a cellulose fiber is synthesized in the present invention, for examples, the pH of the reaction solution is basic at the start of the reaction, but changes to neutral as the carbonation reaction proceeds. Thus, the reaction can be controlled by monitoring the pH of the reaction solution.

In the present invention, stronger cavitation can be generated by increasing the jetting pressure of the liquid because the flow rate of the jetting liquid increases and accordingly the pressure decreases. Moreover, the impact force can be stronger by increasing the pressure in the reaction vessel because the pressure in the region where cavitation bubbles collapse increases and the pressure difference between the bubbles and the surroundings increases so that the bubbles vigorously collapse. This also helps to promote the dissolution and dispersion of carbonic acid gas introduced. The reaction temperature is preferably 0° C. or more and 90° C. or less, especially preferably 10° C. or more and 60° C. or less. Given that the impact force is generally thought to be maximal at the midpoint between the melting point and the boiling point, the temperature is suitably around 50° C. in cases of aqueous solutions, though significant effects can be obtained even at a lower temperature so far as it is within the ranges defined above because there is no influence of vapor pressure.

In the present invention, the energy required for generating cavitation can be reduced by adding a surfactant. Surfactants that may be used include known or novel surfactants, e.g., nonionic surfactants, anionic surfactants, cationic surfactants and amphoteric surfactants such as fatty acid salts, higher alkyl sulfates, alkyl benzene sulfonates, higher alcohols, alkyl phenols, alkylene oxide adducts of fatty acids and the like. These may be used alone or as a mixture of two or more components. They may be added in any amount necessary for lowering the surface tension of the jetting liquid and/or target liquid.

In one preferred embodiment, the average primary particle size of the inorganic particles in the complex fibers of the present invention can be, for example, 1.5 μm or less, or the average primary particle size can be 1200 nm or less, or 900 nm or less, 700 nm or less, 500 nm or less, 300 nm or less, or the average primary particle size can be even 200 nm or less, or 150 nm or less, or 100nm. On the other hand, the average primary particle size of the inorganic particles can be 10 nm or more, 30 nm or more, or 50 nm or more. It should be noted that the average primary particle size can be measured from electron micrographs.

Further, the inorganic particles in the complex fibers of the present invention may take the form of secondary particles resulting from the aggregation of fine primary particles, wherein the secondary particles can be produced to suit the intended purposes via an aging process or aggregates can be broken down by grinding. Grinding means include ball mills, sand grinder mills, impact mills, high pressure homogenizers, low pressure homogenizers, Dyno mills, ultrasonic mills, Kanda grinders, attritors, millstone type mills, vibration mills, cutter mills, jet mills, breakers, beaters, single screw extruders, twin screw extruders, ultrasonic stirrers, juicers/mixers for home use, etc.

(Fibers)

The complex fibers used in the present invention comprise a cellulose fiber complexed with inorganic particles. Examples of cellulose fibers forming part of the complex fibers that can be used include, without limitation, not only natural cellulose fibers but also regenerated fibers (semisynthetic fibers) such as rayon and lyocell and synthetic fibers and the like. Examples of raw materials of cellulose fibers include plant-derived pulp fibers, cellulose nanofibers, bacterial celluloses, animal-derived celluloses such as Ascidiacea, algae, etc., among which wood pulps may be prepared by pulping wood raw materials. Examples of wood raw materials include softwoods such as Pinus densiflora, Pinus thunbergii, Abies sachalinensis, Picea jezoensis, Pinus koraiensis, Larix kaempferi, Abies firma, Tsuga sieboldii, Cryptomeria japonica, Chamaecyparis obtusa, Larix kaempferi, Abies veitchii, Picea jezoensis var. hondoensis, Thujopsis dolabrata, Douglas fir (Pseudotsuga menziesii), hemlock (Conium maculatum), white fir (Abies concolor), spruces, balsam fir (Abies balsamea), cedars, pines, Pinus merkusii, Pinus radiata, and mixed materials thereof; and hardwoods such as Fagus crenata, birches, Alnus japonica, oaks, Machilus thunbergii, Castanopsis, Betula platyphylla, Populus nigra var. italica, poplars, Fraxinus, Populus maximowiczii, Eucalyptus, mangroves, Meranti, Acacia and mixed materials thereof

The technique for pulping the wood raw materials (woody raw materials) is not specifically limited, and examples include pulping processes commonly used in the papermaking industry. Wood pulps can be classified by the pulping process and include, for example, chemical pulps obtained by digestion via the kraft process, sulfite process, soda process, polysulfide process or the like; mechanical pulps obtained by pulping with a mechanical force such as a refiner, grinder or the like; semichemical pulps obtained by pulping with a mechanical force after a chemical pretreatment; waste paper pulps; deinked pulps and the like. The wood pulps may have been unbleached (before bleaching) or bleached (after bleaching).

Examples of non-wood pulps include cotton, hemp, sisal (Agave sisalana), abaca (Musa textilis), flax, straw, bamboo, bagas, kenaf, sugar cane, corn, rice straw, Broussonetia kazinoki×B. papyrifera, Edgeworthia chrysantha and the like.

The pulp fibers may be unbeaten or beaten, and may be chosen depending on the purposes for which the resulting complex fibers are used. Beating allows improving the strength, improving the BET specific surface area and promoting the adhesion of inorganic particles when they are formed into sheets. On the other hand, using unbeaten pulp fibers can not only reduce the risk that inorganic materials may be separated with fibrils when the resulting complex fibers are stirred and/or kneaded in their matrix, but also highly contribute to improving the strength when they are used as reinforcing materials for cement or the like because they can maintain a long fiber length. It should be noted that the degree of beating of a fiber can be expressed by Canadian Standard Freeness (CSF) defined in JIS P 8121-2: 2012. As beating proceeds, the drainage rate through the fiber decreases and its freeness decreases. Fibers having any freeness can be used for the synthesis of the complex fibers, and even those having a freeness of 600 mL or less can be conveniently used. When a complex fiber of the present invention is used to prepare sheets, for example, sheet breaks can be reduced during the process of continuously forming the sheets from a cellulose fiber having a freeness of 600 mL or less. In other words, the freeness decreases by a treatment for increasing the fiber surface area such as beating to improve the strength and specific surface area of complex fiber sheets, but even cellulose fibers having been subjected to such a treatment can be conveniently used. On the other hand, the lower limit of the freeness of cellulose fibers is more preferably 50 mL or more, still more preferably 100 mL or more. If the freeness of cellulose fibers is 200 mL or more, a good runnability can be achieved during continuous sheet forming.

Moreover, these cellulosic raw materials can be further treated, whereby they can also be used as powdered celluloses, chemically modified celluloses such as oxidized celluloses, and cellulose nanofibers (CNFs) (microfibrillated celluloses (MFCs), TEMPO-oxidized CNFs, phosphate esters of CNFs, carboxymethylated CNFs, mechanically ground CNFs and the like). Powdered celluloses used in the present invention may be, for example, rod-like crystalline cellulose powders having a defined particle size distribution prepared by purifying/drying and grinding/sieving the undecomposed residue obtained after acid hydrolysis of an accepted pulp fraction, or may be commercially available products such as KC FLOCK (from Nippon Paper Industries Co., Ltd.), CEOLUS (from Asahi Kasei Chemicals Corp.), AVICEL (from FMC Corporation) and the like. The degree of polymerization of celluloses in the powdered celluloses is preferably in the order of 100 to 1500, and the powdered celluloses preferably have a crystallinity of 70 to 90% as determined by X-ray diffraction and also preferably have a volume average particle size of 1 μm or more and 100 μm or less as determined by a laser diffraction particle size distribution analyzer. Oxidized celluloses used in the present invention can be obtained by oxidation with an oxidizing agent in water in the presence of an N-oxyl compound and a compound selected from the group consisting of a bromide, an iodide or a mixture thereof, for example. Cellulose nanofibers can be obtained by disintegrating the cellulosic raw materials described above. Disintegration methods that can be used include, for example, mechanically grinding or beating an aqueous suspension or the like of a cellulose or a chemically modified cellulose such as an oxidized cellulose using a refiner, high pressure homogenizer, grinder, single screw or multi-screw kneader, bead mill or the like. Cellulose nanofibers may be prepared by using one or a combination of the methods described above. The fiber diameter of the cellulose nanofibers thus prepared can be determined by electron microscopic observation or the like and falls within the range of, for example, 5 nm to 1000 nm, preferably 5 nm to 500 nm, more preferably 5 nm to 300 nm. During the preparation of the cellulose nanofibers, a given compound can be further added before and/or after the celluloses are disintegrated and/or micronized, whereby it reacts with the cellulose nanofibers to functionalize the hydroxyl groups. Functional groups used for the functionalization include acyl groups such as acetyl, ester, ether, ketone, formyl, benzoyl, acetal, hemiacetal, oxime, isonitrile, allene, thiol, urea, cyano, nitro, azo, aryl, aralkyl, amino, amide, imide, acryloyl, methacryloyl, propionyl, propioloyl, butyryl, 2-butyryl, pentanoyl, hexanoyl, heptanoyl, octanoyl, nonanoyl, decanoyl, undecanoyl, dodecanoyl, myristoyl, palmitoyl, stearoyl, pivaloyl, benzoyl, naphthoyl, nicotinoyl, isonicotinoyl, furoyl and cinnamoyl; isocyanate groups such as 2-methacryloyloxyethyl isocyanate; alkyl groups such as methyl, ethyl, propyl, 2-propyl, butyl, 2-butyl, tert-butyl, pentyl, hexyl, heptyl, octyl, nonyl, decyl, undecyl, dodecyl, myristyl, palmityl, and stearyl; oxirane, oxetane, oxyl, thiirane, thietane and the like. Hydrogens in these substituents may be substituted by a functional group such as hydroxyl or carboxyl. Further, the alkyl groups may be partially unsaturated with an unsaturated bond. Compounds used for introducing these functional groups are not specifically limited and include, for example, compounds containing phosphate-derived groups, compounds containing carboxylate-derived groups, compounds containing sulfate-derived groups, compounds containing sulfonate-derived groups, compounds containing alkyl groups, compounds containing amine-derived groups and the like. Phosphate-containing compounds include, but not specifically limited to, phosphoric acid and lithium salts of phosphoric acid such as lithium dihydrogen phosphate, dilithium hydrogen phosphate, trilithium phosphate, lithium pyrophosphate, and lithium polyphosphate. Other examples include sodium salts of phosphoric acid such as sodium dihydrogen phosphate, disodium hydrogen phosphate, trisodium phosphate, sodium pyrophosphate, and sodium polyphosphate. Further examples include potassium salts of phosphoric acid such as potassium dihydrogen phosphate, dipotassium hydrogen phosphate, tripotassium phosphate, potassium pyrophosphate, and potassium polyphosphate. Still further examples include ammonium salts of phosphoric acid such as ammonium dihydrogen phosphate, diammonium hydrogen phosphate, triammonium phosphate, ammonium pyrophosphate, ammonium polyphosphate and the like. Among them, preferred ones include, but not specifically limited to, phosphoric acid, sodium salts of phosphoric acid, potassium salts of phosphoric acid, and ammonium salts of phosphoric acid, and more preferred are sodium dihydrogen phosphate and disodium hydrogen phosphate because they allow phosphate groups to be introduced with high efficiency so that they are convenient for industrial applications. Carboxyl-containing compounds include, but not specifically limited to, dicarboxylic compounds such as maleic acid, succinic acid, phthalic acid, fumaric acid, glutaric acid, adipic acid, and itaconic acid; and tricarboxylic compounds such as citric acid, and aconitic acid. Acid anhydrides of carboxyl-containing compounds include, but not specifically limited to, acid anhydrides of dicarboxylic compounds such as maleic anhydride, succinic anhydride, phthalic anhydride, glutaric anhydride, adipic anhydride, and itaconic anhydride. Derivatives of carboxyl-containing compounds include, but not specifically limited to, imides of acid anhydrides of carboxyl-containing compounds, and derivatives of acid anhydrides of carboxyl-containing compounds. Imides of acid anhydrides of carboxyl-containing compounds include, but not specifically limited to, imides of dicarboxylic compounds such as maleimides, succinimides, and phthalimides. Derivatives of acid anhydrides of carboxyl-containing compounds are not specifically limited. For example, they include acid anhydrides of carboxyl-containing compounds in which hydrogen atoms are at least partially substituted by a substituent (e.g., alkyl, phenyl or the like) such as dimethylmaleic anhydride, diethylmaleic anhydride, and diphenylmaleic anhydride. Among the compounds containing carboxylate-derived groups listed above, preferred ones include, but not specifically limited to, maleic anhydride, succinic anhydride and phthalic anhydride because they are convenient for industrial applications and can be readily gasified. Further, the cellulose nanofibers may be functionalized by a compound physically adsorbed rather than chemically bonded to the cellulose nanofibers. Compounds to be physically adsorbed include surfactants and the like, which may be anionic, cationic, or nonionic. When the celluloses are functionalized as described above before they are disintegrated and/or ground, these functional groups can be removed, giving back the original hydroxyl groups after they are disintegrated and/or ground. The functionalization as described above can promote disintegration into cellulose nanofibers or help cellulose nanofibers to be mixed with various materials during their use.

The fibers shown above may be used alone or as a mixture of two or more of them. For example, fibrous materials collected from waste water of a papermaking factory may be supplied to the carbonation reaction of the present invention. Various composite particles including those of various shapes such as fibrous particles can be synthesized by supplying such materials to the reaction vessel.

In the present invention, materials that are incorporated into the product inorganic particles to form composite particles can be used in addition to a fiber. In the present invention, composite particles incorporating inorganic particles, organic particles, polymers or the like can be prepared by synthesizing inorganic particles in a solution further containing these materials in addition to a fiber such as a pulp fiber.

The fiber length of the fiber to be complexed is not specifically limited, and the average fiber length can be, for example, in the order of 0.1 μm to 15 mm, or may be 1 μm to 12 mm, 100 μm to 10 mm, 500 μm to 8 mm or the like.

The fiber diameter of the fiber to be complexed is not specifically limited, and the average fiber diameter can be, for example, in the order of 1 nm to 100 μm, or may be 10 nm to 100 μm, 0.15 μm to 100 μm, 1 μm to 90 μm, 3 to 50 μm, 5 to 30 μm or the like.

The amount of the fiber to be complexed is not specifically limited so far as it is used in such an amount that 15% or more of the surface of the fiber is covered by inorganic particles, and the weight ratio between the fiber and the inorganic particles can be, for example, 5/95 to 95/5, or may be 10/90 to 90/10, 20/80 to 80/20, 30/70 to 70/30, or 40/60 to 60/40.

In the complex fibers of the present invention, 15% or more of the surface of the fiber is covered by inorganic particles in preferred embodiments, and when the surface of the cellulose fiber is covered at such an area ratio, characteristics attributed to the inorganic particles predominate while characteristics attributed to the fiber surface diminish.

The complex fibers of the present invention can be used in various shapes including, for example, powders, pellets, moldings, aqueous suspensions, pastes, sheets, boards, blocks, yarns and other shapes. Further, the complex fibers can be used as main components with other materials to form molded products such as moldings, particles or pellets. The dryer used to dry them into powder is not specifically limited either, and air-flow dryers, band dryers, spray dryers and the like can be conveniently used, for example.

The complex fibers of the present invention can be used for various applications and they can be widely used for any applications including, for example, papers, fibers, cellulosic composite materials, filter materials, paints, plastics and other resins, rubbers, elastomers, ceramics, glasses, tires, building materials (asphalt, asbestos, cement, boards, concrete, bricks, tiles, plywoods, fiber boards, decorative plywoods, ceiling materials, wall materials, floor materials, roof materials and the like), furniture, various carriers (catalyst carriers, drug carriers, agrochemical carriers, microbial carriers and the like), adsorbents (decontaminants, deodorants, dehumidifying agents and the like), anti-wrinkle agents, clay, abrasives, modifiers, repairing materials, thermal insulation materials, thermal resistant materials, heat dissipating materials, damp proofing materials, water repellent materials, waterproofing materials, light shielding materials, sealants, shielding materials, insect repellents, adhesives, medical materials, paste materials, discoloration inhibitors, electromagnetic wave absorbers, insulating materials, acoustic insulation materials, interior materials, vibration damping materials, semiconductor sealing materials, radiation shielding materials, flame retardant materials, and the like. They also can be used for various fillers, coating agents and the like in the applications mentioned above. Among them, they are preferably applied for radiation shielding materials, flame retardant materials, building materials, furniture, interior materials, and thermal insulation materials.

The complex fibers of the present invention may also be applied for papermaking purposes including, for example, printing papers, newsprint papers, inkjet printing papers, PPC papers, kraft papers, woodfree papers, coated papers, coated fine papers, wrapping papers, thin papers, colored woodfree papers, cast-coated papers, carbonless copy papers, label papers, heat-sensitive papers, various fancy papers, water-soluble papers, release papers, process papers, hanging base papers, flame retardant papers (incombustible papers), base papers for laminated boards, printed electronics papers, battery separators, cushion papers, tracing papers, impregnated papers, papers for ODP, building papers (wall papers and the like), papers for decorative building materials, envelope papers, papers for tapes, heat exchange papers, chemical fiber papers, aseptic papers, water resistant papers, oil resistant papers, heat resistant papers, photocatalytic papers, cosmetic papers (facial blotting papers and the like), various sanitary papers (toilet papers, facial tissues, wipers, diapers, menstrual products and the like), cigarette rolling papers, paperboards (liners, corrugating media, white paperboards and the like), base papers for paper plates, cup papers, baking papers, abrasive papers, synthetic papers and the like. Thus, the present invention makes it possible to provide complexes of inorganic particles having a small primary particle size and a narrow particle size distribution with a fiber so that they can exhibit different properties from those of conventional inorganic fillers having a particle size of more than 2 μm. Further, the complexes of inorganic particles with a fiber can be formed into sheets in which the inorganic particles are not only more readily retained but also uniformly dispersed without being aggregated in contrast to those in which inorganic particles are simply added to a fiber. In a preferred embodiment, the inorganic particles in the present invention are not only adhered to the outer surface and the inside of the lumen of the fiber but also produced within microfibrils, as proved by the results of electron microscopic observation.

Further, the complex fibers of the present invention can be used typically in combination with particles known as inorganic fillers and organic fillers or various fibers. For example, inorganic fillers include calcium carbonate (precipitated calcium carbonate, ground calcium carbonate), magnesium carbonate, barium carbonate, aluminum hydroxide, calcium hydroxide, magnesium hydroxide, zinc hydroxide, clay (kaolin, calcined kaolin, delaminated kaolin), talc, zinc oxide, zinc stearate, titanium dioxide, silica products prepared from sodium silicate and a mineral acid (white carbon, silica/calcium carbonate complexes, silica/titanium dioxide complexes), terra alba, bentonite, diatomaceous earth, calcium sulfate, zeolite, refractory clay, inorganic fillers recycled from ash obtained in a deinking process and inorganic fillers consisting of complexes of ash with silica or calcium carbonate formed during recycling, etc. In the calcium carbonate-silica complexes, amorphous silicas such as white carbon may also be used in addition to calcium carbonate and/or precipitated calcium carbonate-silica complexes. Organic fillers include urea-formaldehyde resins, polystyrene resins, phenol resins, hollow microparticles, acrylamide complexes, wood-derived materials (microfibers, microfibrillar fibers, kenaf powders), modified/insolubilized starches, ungelatinized starches and the like. Fibers that can be used include, without limitation, not only natural fibers such as celluloses but also synthetic fibers artificially synthesized from raw materials such as petroleum, regenerated fibers (semisynthetic fibers) such as rayon and lyocell, and even inorganic fibers and the like. In addition to the examples mentioned above, natural fibers include protein fibers such as wool and silk yarns and collagen fibers; complex carbohydrate fibers such as chitin-chitosan fibers and alginate fibers and the like. Examples of cellulosic raw materials include plant-derived pulp fibers, bacterial celluloses, animal-derived celluloses such as Ascidiacea, algae, etc., among which wood pulps may be prepared by pulping wood raw materials. Examples of wood raw materials include softwoods such as Pinus densiflora, Pinus thunbergii, Abies sachalinensis, Picea jezoensis, Pinus koraiensis, Larix kaempferi, Abies firma, Tsuga sieboldii, Cryptomeria japonica, Chamaecyparis obtusa, Larix kaempferi, Abies veitchii, Picea jezoensis var. hondoensis, Thujopsis dolabrata, Douglas fir (Pseudotsuga menziesii), hemlock (Conium maculatum), white fir (Abies concolor), spruces, balsam fir (Abies balsamea), cedars, pines, Pinus merkusii, Pinus radiata, and mixed materials thereof; and hardwoods such as Fagus crenata, birches, Alnus japonica, oaks, Machilus thunbergii, Castanopsis, Betula platyphylla, Populus nigra var. italica, poplars, Fraxinus, Populus maximowiczii, Eucalyptus, mangroves, Meranti, Acacia and mixed materials thereof. The technique for pulping the wood raw materials is not specifically limited, and examples include pulping processes commonly used in the papermaking industry. Wood pulps can be classified by the pulping process and include, for example, chemical pulps obtained by digestion via the kraft process, sulfite process, soda process, polysulfide process or the like; mechanical pulps obtained by pulping with a mechanical force such as a refiner, grinder or the like; semichemical pulps obtained by pulping with a mechanical force after a chemical pretreatment; waste paper pulps; deinked pulps and the like. The wood pulps may have been unbleached (before bleaching) or bleached (after bleaching). Examples of non-wood pulps include cotton, hemp, sisal (Agave sisalana), abaca (Musa textilis), flax, straw, bamboo, bagas, kenaf, sugar cane, corn, rice straw, Broussonetia kazinoki x B. papyrifera, Edgeworthia chrysantha and the like. The wood pulps and non-wood pulps may be unbeaten or beaten. Moreover, these cellulosic raw materials can be further treated so that they can also be used as powdered celluloses, chemically modified celluloses such as oxidized celluloses, and cellulose nanofibers (CNFs) (microfibrillated celluloses (MFCs), TEMPO-oxidized CNFs, phosphate esters of CNFs, carboxymethylated CNFs, mechanically ground CNFs). Synthetic fibers include polyesters, polyamides, polyolefins, and acrylic fibers; semisynthetic fibers include rayon, acetate and the like; and inorganic fibers include glass fiber, ceramic fibers, biodegradable ceramic fibers, carbon fiber, various metal fibers and the like. All these may be used alone or as a combination of two or more of them.

The average particle size or shape or the like of the inorganic particles forming part of the complex fibers of the present invention can be identified by electron microscopic observation. Further, inorganic particles having various sizes or shapes can be complexed with a fiber by controlling the conditions under which the inorganic particles are synthesized.

(Synthesis of Complex Fibers)

In one embodiment of the present invention, a complex can be synthesized by synthesizing inorganic particles by a known method in a solution containing a fiber.

In cases where barium sulfate is to be used as inorganic particles, barium sulfate may be synthesized in a solution containing a fiber. When an alkaline precursor of barium sulfate such as barium hydroxide is used as a starting material, for example, a complex of barium sulfate and a fiber can be obtained with good efficiency because the fiber can be swollen by dispersing the fiber in a solution of the precursor of barium sulfate in advance. The reaction can be started after swelling of the fiber has been promoted by mixing them and then stirring the mixture for 15 minutes or more, or the reaction may be started immediately after mixing them. The shape of the reaction vessel and stirring conditions for obtaining such a complex fiber are not specifically limited, and a complex may be synthesized by stirring/mixing a solution containing a fiber and a precursor of barium sulfate in an open reaction vessel or injecting an aqueous suspension containing a fiber and a precursor of barium sulfate into a reaction vessel. In this process, an aging period may be provided during or after the reaction for the purpose of controlling the particle size of the inorganic material or optimizing the reaction conditions (nucleation reaction or growth reaction). For example, the reaction may be maintained at a low pH range if the inorganic material is synthesized more readily at such a range or the solution may be continuously stirred if it takes long for the growth reaction of inorganic particles. In this case, the aging period and pH are not limited, and any of the neutral range of pH 6 to 8, the acidic range of pH 6 or less, and the alkaline range of pH 8 or more can be applied.

In the present invention, water is used for preparing suspensions or for other purposes, in which case not only common tap water, industrial water, groundwater, well water and the like can be used, but also ion-exchanged water, distilled water, ultrapure water, industrial waste water, and the water obtained during the separation/dehydration of the reaction solution can be conveniently used.

Further in the present invention, the reaction solution in the reaction vessel can be used in circulation. By circulating the reaction solution in this way to promote stirring of the reaction solution, the reaction efficiency increases and a desired complex of inorganic particles and a fiber can be readily obtained.

For preparing the complex fibers of the present invention, various known auxiliaries can also be added. For example, chelating agents can be added, specifically including polyhydroxycarboxylic acids such as citric acid, malic acid, and tartaric acid; dicarboxylic acids such as oxalic acid; sugar acids such as gluconic acid; aminopolycarboxylic acids such as iminodiacetic acid and ethylenediamine tetraacetic acid and alkali metal salts thereof; alkali metal salts of polyphosphoric acids such as hexametaphosphoric acid and tripolyphosphoric acid; amino acids such as glutamic acid and aspartic acid and alkali metal salts thereof; ketones such as acetylacetone, methyl acetoacetate and allyl acetoacetate; sugars such as sucrose; and polyols such as sorbitol. Surface-treating agents can also be added, including saturated fatty acids such as palmitic acid and stearic acid; unsaturated fatty acids such as oleic acid and linoleic acid; alicyclic carboxylic acids; resin acids such as abietic acid; as well as salts, esters and ethers thereof; alcoholic activators, sorbitan fatty acid esters, amide- or amine-based surfactants, polyoxyalkylene alkyl ethers, polyoxyethylene nonyl phenyl ether, sodium alpha-olefin sulfonate, long-chain alkylamino acids, amine oxides, alkylamines, quaternary ammonium salts, aminocarboxylic acids, phosphonic acids, polycarboxylic acids, condensed phosphoric acids and the like. Further, dispersants can also be used, if desired. Such dispersants include, for example, sodium polyacrylate, sucrose fatty acid esters, glycerol esters of fatty acids, ammonium salts of acrylic acid-maleic acid copolymers, methacrylic acid-naphthoxypolyethylene glycol acrylate copolymers, ammonium salts of methacrylic acid-polyethylene glycol monomethacrylate copolymers, polyethylene glycol monoacrylate and the like. These can be used alone or as a combination of two or more of them. They may be added before or after the synthesis reaction. Such additives can be added preferably in an amount of 0.001 to 20%, more preferably 0.1 to 10% of inorganic particles.

The reaction conditions under which complex fibers are synthesized in the present invention are not specifically limited, and can be appropriately selected depending on the purposes. For example, the temperature of the synthesis reaction can be 0 to 90° C., preferably 10 to 70° C. The reaction temperature can be controlled by regulating the temperature of the reaction solution using a temperature controller, and if the temperature is low, the reaction efficiency decreases and the cost increases, but if it exceeds 90° C., coarse inorganic particles tend to increase.

Further in the present invention, the reaction can be a batch reaction or a continuous reaction. Typically, the reaction is preferably performed by a batch reaction process because of the convenience in removing residues after the reaction. The scale of the reaction is not specifically limited, and can be 100 L or less, or more than 100 L. The volume of the reaction vessel can be, for example, in the order of 10 L to 100 L, or may be in the order of 100 L to 1000 L, or 1 m³ (1000 L) to 100 m³.

Furthermore, the reaction can be controlled by the conductivity of the reaction solution or the reaction period, and specifically it can be controlled by adjusting the period during which the reactants stay in the reaction vessel. Additionally, the reaction can also be controlled in the present invention by stirring the reaction solution in the reaction vessel or performing the reaction as a multistage reaction.

In the present invention, the reaction product complex fiber is obtained as a suspension so that it can be stored in a storage tank or subjected to processing such as concentration, dehydration, grinding, classification, aging, or dispersion, as appropriate. These can be accomplished by known processes, which may be appropriately selected taking into account the purposes, energy efficiency and the like. For example, the concentration/dehydration process is performed by using a centrifugal dehydrator, thickener or the like. Examples of such centrifugal dehydrators include decanters, screw decanters and the like. If a filter or dehydrator is used, the type of it is not specifically limited either, and those commonly used can be used, including, for example, pressure dehydrators such as filter presses, drum filters, belt presses and tube presses or vacuum drum filters such as Oliver filters or the like, which can be conveniently used to give a cake. Grinding means include ball mills, sand grinder mills, impact mills, high pressure homogenizers, low pressure homogenizers, Dyno mills, ultrasonic mills, Kanda grinders, attritors, millstone type mills, vibration mills, cutter mills, jet mills, breakers, beaters, single screw extruders, twin screw extruders, ultrasonic stirrers, juicers/mixers for home use, etc. Classification means include sieves such as meshes, outward or inward flow slotted or round-hole screens, vibrating screens, heavyweight contaminant cleaners, lightweight contaminant cleaners, reverse cleaners, screening testers and the like. Dispersion means include high speed dispersers, low speed kneaders and the like.

The complex fibers in the present invention can be compounded into fillers or pigments as a suspension without being completely dehydrated, or can be dried into powder. The dryer used in the latter case is not specifically limited either, and air-flow dryers, band dryers, spray dryers and the like can be conveniently used, for example.

The complex fibers of the present invention can be modified by known methods. In one embodiment, for example, they can be hydrophobized on their surface to enhance the miscibility with resins or the like.

(Shapes of the Complex Fibers)

In the present invention, flame-retarded complex fibers having greatly improved flame retardancy can be obtained by treating the complex fibers described above with a flame retardant. The shape of the resulting complex fibers is not specifically limited, and various molded products (articles) can be obtained. For example, the complex fibers of the present invention can be readily formed into sheets having a high ash content. Further, the resulting sheets can be laminated to form multilayer sheets. Paper machines (sheet-forming machines) used for preparing sheets include, for example, Fourdrinier machines, cylinder machines, gap formers, hybrid formers, multilayer paper machines, known sheet-forming machines combining the papermaking methods of these machines and the like. The linear pressure in the press section of the paper machines and the linear calendering pressure in a subsequent optional calendering process can be both selected within a range convenient for the runnability and the performance of the complex fiber sheets. Further, the sheets thus formed may be impregnated or coated with starches, various polymers, pigments and mixtures thereof.

During sheet forming, wet and/or dry strength additives (paper strength additives) can be added. This allows the strength of the complex fiber sheets to be improved. Strength additives include, for example, resins such as urea-formaldehyde resins, melamine-formaldehyde resins, polyamides, polyamines, epichlorohydrin resins, vegetable gums, latexes, polyethylene imines, glyoxal, gums, mannogalactan polyethylene imines, polyacrylamide resins, polyvinylamines, and polyvinyl alcohols; composite polymers or copolymers composed of two or more members selected from the resins listed above; starches and processed starches; carboxymethyl cellulose, guar gum, urea resins and the like. The amount of the strength additives to be added is not specifically limited.

Further, high molecular weight polymers or inorganic materials can also be added to promote the adhesion of fillers to fibers or to improve the retention of fillers or fibers. For example, coagulants can be added, including cationic polymers such as polyethylene imines and modified polyethylene imines containing a tertiary and/or quaternary ammonium group, polyalkylene imines, dicyandiamide polymers, polyamines, polyamine/epichlorohydrin polymers, polymers of dialkyldiallyl quaternary ammonium monomers, dialkylaminoalkyl acrylates, dialkylaminoalkyl methacrylates, dialkylaminoalkyl acrylamides and dialkylaminoalkyl methacrylamides with acrylamides, monoamine/epihalohydrin polymers, polyvinylamines and polymers containing a vinylamine moiety as well as mixtures thereof; cation-rich zwitterionic polymers containing an anionic group such as a carboxyl or sulfone group copolymerized in the molecules of the polymers listed above; mixtures of a cationic polymer and an anionic or zwitterionic polymer and the like. Further, retention aids such as cationic or anionic or zwitterionic polyacrylamide-based materials can be used. These may be applied as retention systems called dual polymers in combination with at least one or more cationic or anionic polymers or may be applied as multicomponent retention systems in combination with at least one or more anionic inorganic microparticles such as bentonite, colloidal silica, polysilicic acid, microgels of polysilicic acid or polysilicic acid salts and aluminum-modified products thereof or one or more organic microparticles having a particle size of 100 μm or less called micropolymers composed of crosslinked/polymerized acrylamides. Especially when the polyacrylamide-based materials used alone or in combination with other materials have a weight-average molecular weight of 2,000,000 Da or more, preferably 5,000,000 Da or more as determined by intrinsic viscosity measurement, good retention can be achieved, and when the acrylamide-based materials have a molecular weight of 10,000,000 Da or more and less than 30,000,000 Da, very high retention can be achieved. The polyacrylamide-based materials may be in the form of an emulsion or a solution. Specific compositions of such materials are not specifically limited so far as they contain an acrylamide monomer unit as a structural unit therein, but include, for example, copolymers of a quaternary ammonium salt of an acrylic acid ester and an acrylamide, or ammonium salts obtained by copolymerizing an acrylamide and an acrylic acid ester, followed by quaternization. The cationic charge density of the cationic polyacrylamide-based materials is not specifically limited.

Other additives include freeness improvers, internal sizing agents, pH modifiers, antifoaming agents, pitch control agents, slime control agents, bulking agents, inorganic particles (the so-called fillers) such as calcium carbonate, kaolin, talc and silica and the like depending on the purposes. The amount of these additives to be used is not specifically limited.

The basis weight of the sheets can be appropriately controlled depending on the purposes, and it is advantageously 60 to 1200 g/m² for use as, for example, building materials because of high strength and low drying load during preparation. Given that sheets having a higher basic weight (basis weight: the weight per square meter) are more advantageous to increase flame retardancy, the basis weight can be 1200 g/m² or more, e.g., 2000 to 110000 g/m².

Molding techniques other than sheet forming may also be used, and molded products having various shapes can be obtained by the so-called pulp molding process involving casting a raw material into a mold and then dewatering by suction and drying it or the process involving spreading a raw material over the surface of a molded product of a resin or metal or the like and drying it, and then releasing the dried material from the substrate or other processes. Further, the complexes can be molded like plastics by mixing them with a resin. Alternatively, the complexes can be formed into boards or blocks by compression molding under pressure and heat as typically used for preparing inorganic boards of cement or gypsum. The complexes can be not only formed into sheets that can typically be bent or rolled up, but also formed into boards if more strength is needed. They can also be formed into thick masses, i.e., blocks in the form of a rectangular cuboid or a cube, for example. All of these pulp moldings, boards or blocks can be formed to represent a raised and recessed pattern by using a patterned mold during molding or can be reshaped by bending after molding.

In the compounding/drying/molding steps shown above, only one complex can be used, or a mixture of two or more complexes can be used. Two or more complexes can be used as a premix of them or can be mixed after they have been individually compounded, dried and molded.

Further, various organic materials such as polymers or various inorganic materials such as pigments may be added later to the molded products of the complexes.

The molded products prepared from the complexes of the present invention can be printed on. The method for printing is not specifically limited, and known methods can be used including, for example, offset printing, silkscreen printing, screen printing, gravure printing, microgravure printing, flexographic printing, letterpress printing, sticker printing, business form printing, on demand printing, furnisher roll printing, inkjet printing and the like. Among them, inkjet printing is preferred in that a comprehensive layout need not be prepared in contrast to offset printing and it can be performed even on large sheets because inkjet printers can be relatively easily made in a larger size. On the other hand, flexographic printing can be conveniently used even for molded products having such a shape as a board, molding or block because it can also be successfully performed on molded products having a relatively uneven surface.

Further, the printed image formed by printing may have any type of pattern as desired including, but not specifically limited to, wood texture patterns, stone texture patterns, fabric texture patterns, objective patterns, geometric patterns, letters, symbols, or a combination thereof, or may be filled with a solid color.

### EXAMPLES

The present invention will be further explained with reference to specific experimental examples, but the present invention is not limited to these specific examples. Unless otherwise specified, the concentrations, parts and the like as used herein are based on weight, and the numerical ranges are described to include their endpoints.

It should be noted that “bleached hardwood kraft pulp” and “bleached softwood kraft pulp” are sometimes abbreviated herein as “NBKP” and “LBKP”, respectively (both LBKP and NBKP are available from Nippon Paper Industries Co., Ltd.). The Canadian Standard Freeness (CSF) was adjusted by using a single disc refiner (SDR) or a Niagara beater. The average fiber length of pulp in pulp slurries was determined by a fiber tester (from Lorentzen & Wettre).

Experiment 1: Preparation of Complex Fibers of Inorganic Particles With a Fiber

(Sample 1) A Complex Fiber of Barium Sulfate and Aluminum Hydroxide with a Cellulose Fiber

In a reaction vessel (a machine chest having an internal volume of 4 m³), a 2% pulp slurry (bleached hardwood kraft pulp/bleached softwood kraft pulp=8/2, CSF=390 mL, average fiber length: about 1.3 mm, solids content 25 kg) and barium hydroxide octahydrate (from NIPPON CHEMICAL INDUSTRIAL CO., LTD., 75 kg) were mixed, and then aluminum sulfate (98 kg) was added dropwise at a rate of about 500 g/min using a peristaltic pump. After completion of the dropwise addition, stirring was continued for 30 minutes to give Sample 1 (FIG. 3).

(Sample 2) A Complex Fiber of Magnesium Carbonate With a Cellulose Fiber

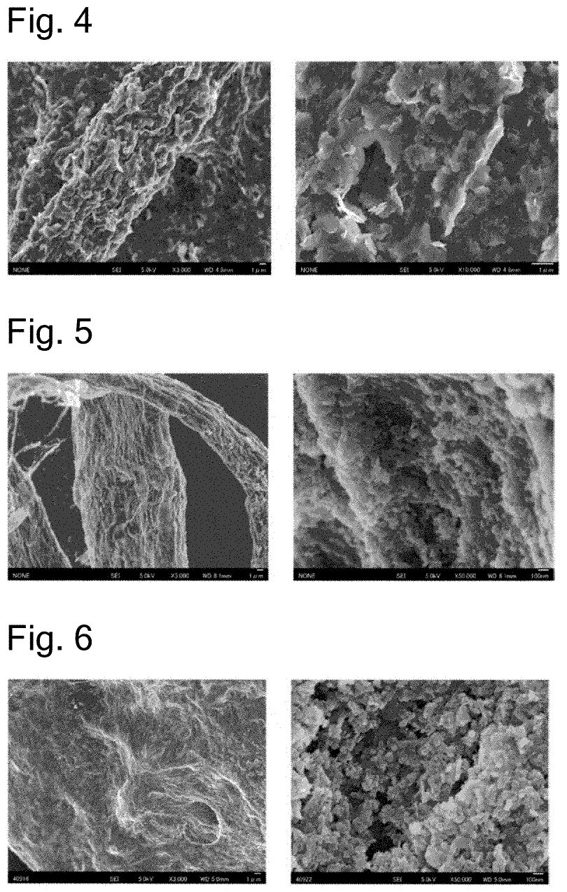

An aqueous suspension in an amount of 170 L containing 5250 g of magnesium hydroxide (UD653 from Ube Material Industries, Ltd.) and 3500 g of a kraft pulp (LBKP, CSF=360 mL, average fiber length=0.76 mm) was prepared. A 500-L cavitation system was charged with this suspension and carbonic acid gas was injected into the reaction vessel while circulating the reaction solution to synthesize a complex of magnesium carbonate microparticles with a fiber by the carbonation process. The reaction temperature was about 40° C., the carbonic acid gas source was a commercially available liquefied gas, and the injection flow rate of the carbonic acid gas was 20 L/min. When the pH of the reaction solution reached about 7.8 (from the pH of about 9.5 before the reaction), the injection of CO₂ was stopped, after which the generation of cavitation and the circulation of the slurry within the system were continued for 30 minutes to give Sample 2 (FIG. 4).

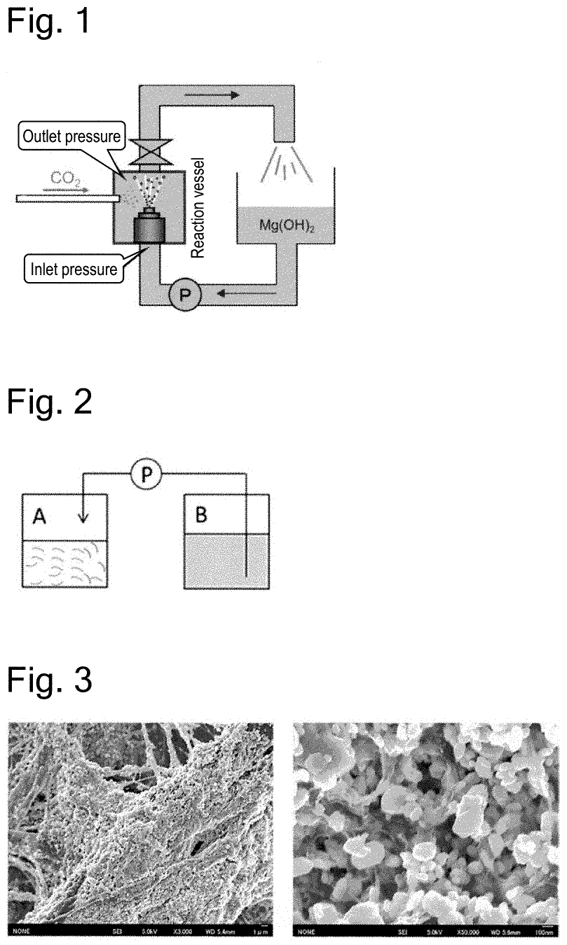

During the synthesis of the complex fiber, cavitation bubbles were generated in the reaction vessel by injecting the reaction solution into the reaction vessel while circulating it, as shown in FIG. 1. Specifically, cavitation bubbles were generated by injecting the reaction solution through a nozzle (nozzle diameter: 1.5 mm) under high pressure at a jet flow rate of about 70 m/s, an inlet pressure (upstream pressure) of 1.8 MPa and an outlet pressure (downstream pressure) of 0.3 MPa.

(Sample 3) A Complex Fiber of Hydrotalcite Particles With a Cellulose Fiber

First, solutions for synthesizing hydrotalcite (HT) were prepared. An aqueous mixed solution of Na₂CO₃ (Wako Pure Chemical Industries, Ltd.) and NaOH (Wako Pure Chemical Industries, Ltd.) was prepared as an alkaline solution (solution A). On the other hand, an aqueous mixed solution of MgSO₄ (Wako Pure Chemical Industries, Ltd.) and Al₂ (SO₄)₃ (Wako Pure Chemical Industries, Ltd.) was prepared as an acid solution (solutions B).
Alkaline solution (solution A): Na₂CO₃ concentration: 0.1 M, NaOH concentration: 1.6 M;
Acid solution (solution B): MgSO₄ concentration: 0.6 M, Al₂ (SO₄)₃ concentration: 0.1 M.

Then, a pulp fiber (LBKP/NBKP=8/2) was added to the alkaline solution (solution A) to prepare an aqueous suspension containing the pulp fiber (pulp solids 30 g, pulp fiber consistency: 1.56%, pH: about 12.4). A 10-L reaction vessel was charged with this aqueous suspension, and the acid solution (solution B) was added dropwise while stirring the aqueous suspension to synthesize a complex fiber of hydrotalcite particles and the fiber (the amount of solution A: 1.1 L, the amount of solution B: 1.1 L). A system as shown in FIG. 2 was used at a reaction temperature of 60° C. and a dropwise addition rate of 5 ml/min, and when the pH of the reaction solution reached about 7, the dropwise addition was stopped. After completion of the dropwise addition, the reaction solution was stirred for 30 minutes, and washed with about 10 volumes of water to remove the salt (FIG. 5).

(Sample 4) A Complex Fiber of Hydrotalcite Particles With a Cellulose Fiber

A complex fiber was synthesized in the same manner as described for Sample 3 except that the amount of each of solution A and solution B was 1.6 L to give Sample 4 (FIG. 6).

(Sample 5) A Complex Fiber of Silica/Alumina Particles With a Cellulose Fiber

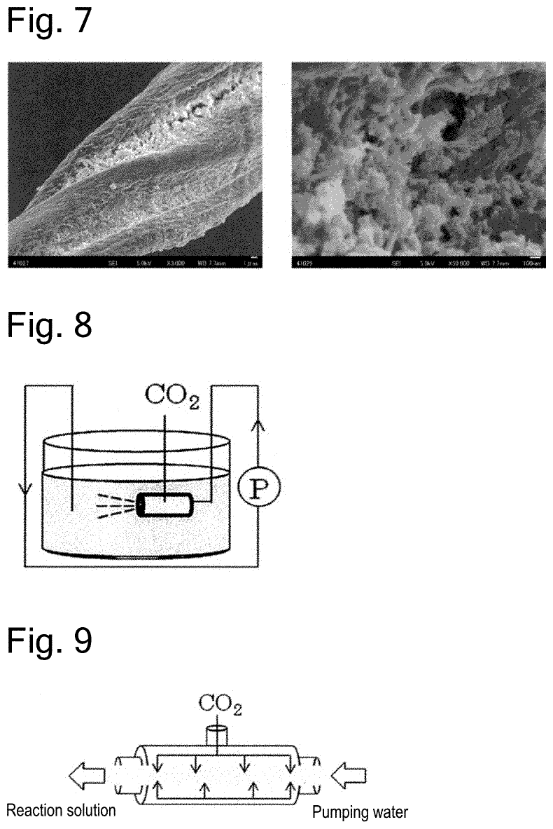

In a resin vessel (5 L), 2.2 L of an aqueous suspension containing 30 g of NBKP (CSF: 510 mL) was stirred using a laboratory mixer (500 rpm). To this aqueous suspension was added dropwise an aqueous aluminum sulfate solution (industrial grade aluminum sulfate, concentration 9%) for about 10 minutes until the pH reached 3.7, and then an aqueous aluminum sulfate solution (industrial grade aluminum sulfate, concentration 9%) and an aqueous sodium silicate solution (from Wako Pure Chemical Industries, concentration 8%) were added dropwise at the same time for about 90 minutes to maintain the pH at 4. A peristaltic pump was used for the dropwise addition, and the reaction temperature was about 24° C. After the dropwise addition, stirring was continued for about 30 minutes, and then an aqueous sodium silicate solution (from Wako Pure Chemical Industries, concentration 8%) was added dropwise again for about 30 minutes to adjust the pH at 8.0. The total amounts of the aqueous aluminum sulfate solution and aqueous sodium silicate solution used were 155 g and 150 g, respectively. Thus, a complex fiber of silica/alumina particles with a cellulose fiber was synthesized (FIG. 7).

(Sample 6) A Complex Fiber of Calcium Carbonate Particles With a Cellulose Fiber

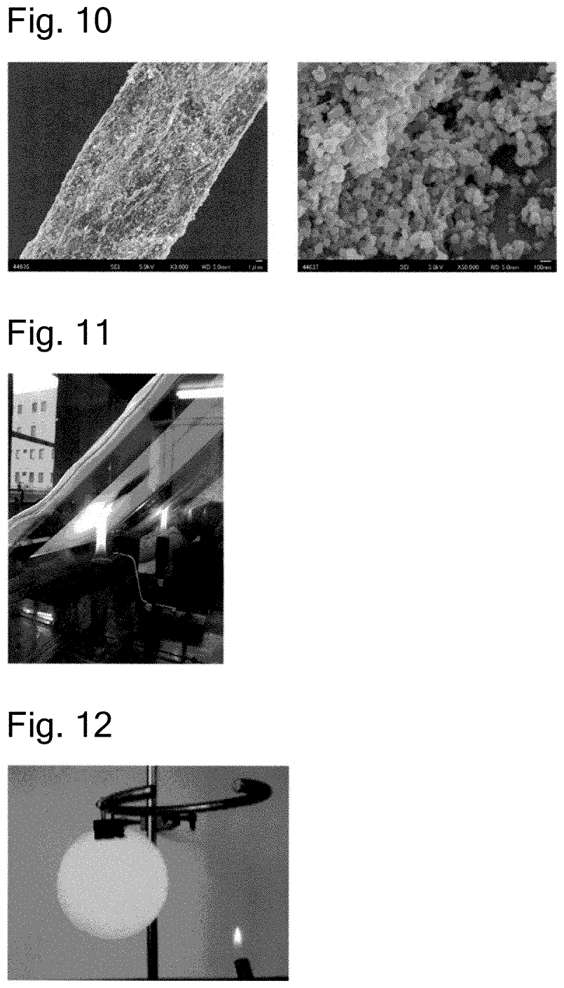

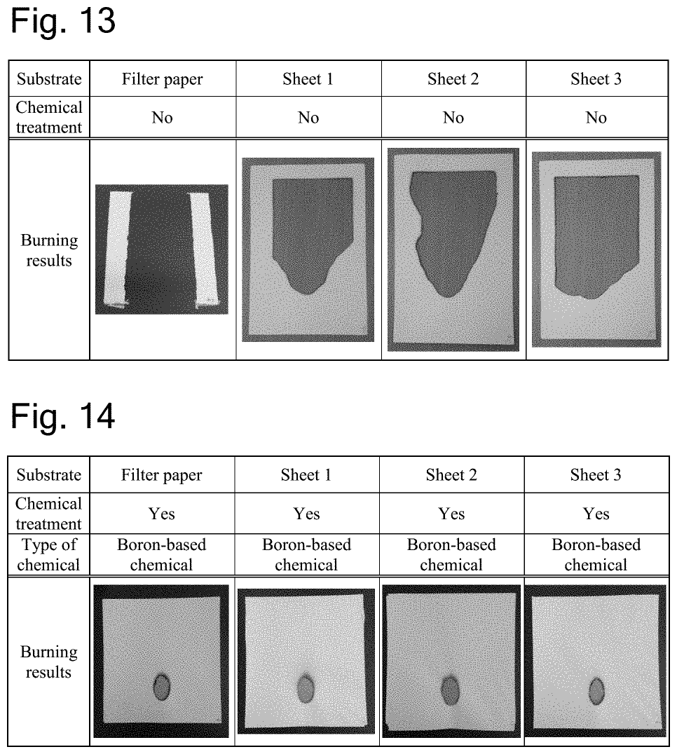

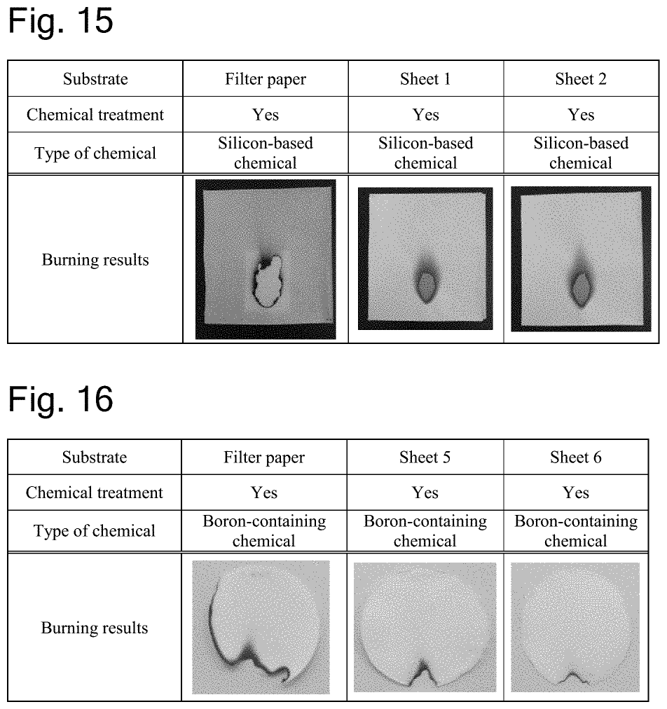

Using a reaction system as shown in WO2018/047749 (FIG. 8), an aqueous suspension containing a pulp fiber (LBKP/NBKP=8/2, CSF=377 mL) was reacted at an initial reaction temperature of about 15° C. and a carbonic acid gas injection flow rate of 3 L/min, and when the pH of the reaction solution reached 7 to 8, the reaction was stopped. A lot of ultrafine bubbles (average particle size: 137 nm, lifespan of bubbles: 60 minutes or more) containing carbonic acid gas were generated in the reaction solution by feeding carbonic acid gas to an ultrafine bubble generator (a shear-induced type YJ-9 from ENVIRO VISION CO., LTD., FIG. 9) to synthesize calcium carbonate particles on the cellulose fiber by the carbonation process, thereby synthesizing a complex fiber of Sample 6 (FIG. 10).

### <Evaluation of the Complex Fiber Samples>

The resulting samples were evaluated by the following procedure.

A slurry of each complex fiber (3 g on a solids basis) was filtered by suction through a filter paper, and then the residue was dried in an oven (105° C., 2 hours) and the weight ratio between the fiber and the inorganic particles in the complex fiber was determined.

Each complex fiber sample was washed with ethanol, and then observed with an electron microscope (FIGS. 3 to 7, 10). The results showed that the inorganic material covered the fiber surface and spontaneously adhered to it in each sample. The primary particle sizes of the inorganic particles estimated from the results of electron microscopic observation are shown in Table 1 below.

TABLE 1

| | | | | | | Average |
|---|---|---|---|---|---|---|
| | | Type of | Fiber:inorganic | Coverage | Primary particle | primary particle |
| | | inorganic | particles | ratio | size of inorganic | size of inorganic |
| | Fiber | particles | (weight ratio) | (%) | particles (nm) | particles (nm) |
| Sample 1 | LBKP/NBKP | Ba sulfate | 27:73 | 98 | 50-1000 | 80 |
| Sample 2 | LBKP | Mg carbonate | 45:55 | 92 | 500-1500 | 800 |
| Sample 3 | LBKP/NBKP | Hydrotalcite | 50:50 | 95 | 40-60 | 50 |
| Sample 4 | LBKP/NBKP | Hydrotalcite | 27:73 | 96 | 20-100 | 50 |
| Sample 5 | NBKP | Silica/alumina | 82:18 | 92 | 80-200 | 150 |
| Sample 6 | LBKP/NBKP | Ca carbonate | 44:56 | 89 | 20-100 | 70 |

Experiment 2: Preparation and Chemical Treatment of Complex Fiber Sheets

### <Preparation of Complex Fiber Sheets>

The complex fibers of Samples 1 to 6 were formed into sheets. Each sheet was measured for its basis weight according to JIS P 8124: 1998 and for its ash content according to JIS P 8251: 2003.

(Sheet 1) Sheet of Sample 1

To a slurry of a complex fiber (Sample 1, consistency: about 1%) was added 100 ppm each on a solids basis of an anionic retention aid (FA230 from HYMO CORPORATION) and a cationic retention aid (ND300 from HYMO CORPORATION) to prepare a slurry (an aqueous suspension). Then, a sheet was prepared from this slurry using a Fourdrinier machine under the conditions of a machine speed of 10 m/min (basis weight: about 160 g/m², ash content: about 64%).

(Sheet 2) Sheet of Sample 2

A sheet of Sample 2 was prepared in the same manner as described for Sheet 1 using a Fourdrinier machine (basis weight: about 100 g/m², ash content: about 43%).

(Sheet 3) Sheet of Sample 3

A sheet of Sample 3 was prepared in the same manner as described for Sheet 1 using a Fourdrinier machine (basis weight: about 100 g/m², ash content: about 33%).

(Sheet 4) Sheet of Sample 4

An aqueous suspension of Sample 4 (about 0.5%) was stirred with 200 ppm of a cationic retention aid (ND300 from HYMO CORPORATION) and 200 ppm of an anionic retention aid (FA230 from HYMO CORPORATION) at 500 rpm to prepare a suspension. A complex fiber sheet was prepared from the resulting suspension according to JIS P 8222 in a square handsheet former (basis weight: about 170 g/m², ash content: 61%).

(Sheet 5) Sheet of Sample 5

An aqueous suspension of Sample 5 (about 0.5%) was poured into a Buchner funnel fitted with a filter paper (standard grade No. 5B filter paper having a diameter of 90 mm from ADVANTEC). After standing still for 10 seconds, the wet web obtained by filtration under suction was dried to prepare a complex fiber sheet (diameter: about 95 mm, basis weight: about 135 g/m², ash content: 18%).

(Sheet 6) Sheet of Sample 6

A sheet of Sample 6 was prepared in the same manner as described above for Sheet 5 except that an aqueous suspension of Sample 6 was used (diameter: about 95 mm, basis weight: about 135 g/m², ash content: 56%).

<Flame Retardation Treatment of Sheets>

### (a) Treatment of Sheets With a Boron-Based Chemical

Each of the sheet samples shown below was sprayed with a boron-based chemical (brand name: SOUFA from Soufa Inc.), and then pressed between a metal plate and an aluminum foil with a roller to remove an excessive amount of the chemical. Then, it was dried under tension in a dryer at 60° C. for 1 hour to give a chemically treated sheet.
Complex fiber sheets (sheets 1 to 4)
Filter paper (standard grade No. 1 filter paper from ADVANTEC, 260 mm×260 mm)
Copy paper (brand name: EP GAAA5989 from FUJI XEROX, A4 size)
Inkjet printer paper (matte IJ paper from Nippon Paper Industries Co., Ltd., A4 size)

### (b) Treatment of Sheets With a Silicon-Based Chemical

The sheets were chemically treated in the same manner as described above in (a) except that the chemical used was a silicon-based chemical (brand name: Crystal Sealer from Bokuto Kasei Kogyo KK).

### (c) Treatment of Sheets With a Phosphorus- and Nitrogen-Based Chemical

Each of the sheet samples shown below was immersed in a phosphorus- and nitrogen-based chemical (brand name: TAIEN N from TAIYO CHEMICAL INDUSTRY CO., LTD., a 40 wt % aqueous solution), and then pressed between a metal plate and an aluminum foil with a roller to remove an excessive amount of the chemical. Then, it was dried under tension in a dryer at 50° C. for 2 hours to give a chemically treated sheet.
A complex fiber sheet (sheet 5)
Filter paper (standard grade No. 5B filter paper from ADVANTEC, diameter 90 mm)

### (d) Treatment of Sheets With a Boron-Containing Chemical

Each of the sheet samples shown below was chemically treated in the same manner as described above in (c) except that the chemical used was a boron-containing chemical (brand name: UBCERA from ISHIZUKA GLASS CO., LTD., 10 wt %).
Complex fiber sheets (sheets 5, 6)
Filter paper (standard grade No. 5B filter paper from ADVANTEC, diameter 90 mm).

<Calculation of the Chemical Contents>

The chemical contents (on a solids basis) of the sheets chemically treated as described above were calculated by the equation below:

Chemical content (on a solids basis) [%]=(M₁−M₀)/M₀

wherein M₀ denotes the bone dry weight [g] of each sheet before chemical treatment, and Mi denotes the bone dry weight [g] of the sheet after chemical treatment.

TABLE 2-1

| | | | Treated with a | Treated with a |
|---|---|---|---|---|
| | | | boron-based | silicon-based |
| Substrate (chemically untreated) | | | chemical | chemical |
| | Sheet | | Sheet weight | Sheet weight |
| | weight | | (Chemical | (Chemical |
| Substrate | [g/m²] | Complex fiber | content) | content) |
| Filter | 100 | — | 126 g/m² | 140 g/m² |
| paper | | | (26 g/m²) | (40 g/m²) |
| Sheet 1 | 160 | Sample 1 (Pulp | 174 g/m² | 187 g/m² |
| | | fiber + Ba | (14 g/m²) | (27 g/m²) |
| | | sulfate) | | |
| Sheet 2 | 100 | Sample 2 (Pulp | 114 g/m² | 124 g/m² |
| | | fiber + Mg | (14 g/m²) | (24 g/m²) |
| | | carbonate) | | |
| Sheet 3 | 100 | Sample 3 (Pulp | 120 g/m² | 133 g/m² |
| | | fiber + HT) | (20 g/m²) | (33 g/m²) |

| | | | Treated with a |
|---|---|---|---|
| | | | phosphorus/nitrogen- |
| Substrate (chemically untreated) | | | based chemical |
| | Sheet weight | | Sheet weight |
| Substrate | [g/m²] | Complex fiber | (Chemical content) |
| Filter | 105 | — | 190 g/m² |
| paper | | | (85 g/m²) |
| Sheet 5 | 134 | Sample 5 (Pulp fiber + | 236 g/m² |
| | | silica/alumina) | (102 g/m²) |
| | | | Treated with a boron- |
| Substrate (chemically untreated) | | | containing chemical |
| | Sheet weight | | Sheet weight |
| Substrate | [g/m²] | Complex fiber | (Chemical content) |
| Filter | 103 | — | 118 g/m² |
| paper | | | (16 g/m²) |
| Sheet 5 | 137 | Sample 5 (Pulp fiber + | 157 g/m² |
| | | silica/alumina) | (19 g/m²) |
| Sheet 6 | 134 | Sample 6 (Pulp fiber + | 149 g/m² |
| | | Ca carbonate) | (16 g/m²) |

<Evaluation of the Flexibility of the Chemically Treated Sheets>

The flexibility of the sheets before and after chemical treatment was evaluated. Specifically, chemical treatment-induced changes in the flexibility of each sheet were evaluated on a 4-point rating scale according to the resistance felt when bending the sheet by both hands as compared with the sheet before chemical treatment. The evaluation criteria are as shown below, wherein point 4 indicates that the flexibility of the sheet was not compromised after chemical treatment, while point 1 indicates that the sheet became stiff and brittle by chemical treatment.

(Evaluation of Flexibility)
Point 4: No change in flexibility before and after chemical treatment.
Point 3: The sheet became slightly stiff after chemical treatment.
Point 2: The sheet became moderately stiff after chemical treatment.
Point 1: The sheet became stiff after chemical treatment.

The evaluation results of the flexibility of each sheet are shown in the table below, which demonstrates that all of the chemically treated commercially available papers (inkjet printer paper and filter paper) tended to be very stiff and considerably brittle sheets. However, chemically treated Samples 1 to 6 (complex fiber sheets) were flexible sheets as compared with the commercially available papers, showing that flexibility was less influenced by chemical treatment. This proves that when complex fiber sheets are used as substrates, the flexibility of the fibers and the sheets formed therefrom is maintained even after chemical treatment.

TABLE 2-2

| | Inorganic | | Chemical | Inorganic | Flexibility |
|---|---|---|---|---|---|
| | fraction | Type of | content | material | after chemical |
| Substrate | in the sheet | chemical | [% vs total] | complexed | treatment |
| Sheet 1 | 64 | Boron-based | 8 | Ba sulfate | 4.0 |
| | | chemical | | | |
| Sheet 2 | 43 | Boron-based | 12 | Mg carbonate | 3.0 |
| | | chemical | | | |
| Sheet 3 | 33 | Boron-based | 16 | Hydrotalcite | 4.0 |
| | | chemical | | | |
| IJ paper | 26 | Boron-based | 11 | — | 2.0 |
| | | chemical | | | |
| Sheet 1 | 64 | Silicon-based | 14 | Ba sulfate | 3.0 |
| | | chemical | | | |
| Sheet 2 | 43 | Silicon-based | 20 | Mg carbonate | 3.0 |
| | | chemical | | | |
| Sheet 3 | 33 | Silicon-based | 24 | Hydrotalcite | 2.0 |
| | | chemical | | | |
| IJ paper | 26 | Silicon-based | 18 | — | 1.0 |
| | | chemical | | | |
| Sheet 5 | 18 | Phosphorus/ | 43 | Silica/ | 2.5 |
| | | nitrogen-based | | alumina | |
| | | chemical | | | |
| Filter | 0 | Phosphorus/ | 45 | — | 1.0 |
| paper | | nitrogen-based | | | |
| | | chemical | | | |
| Sheet 5 | 18 | Boron-containing | 12 | Silica/ | 3.0 |
| | | chemical | | alumina | |
| Sheet 6 | 56 | Boron-containing | 10 | Calcium | 4.0 |
| | | chemical | | carbonate | |
| Filter | 0 | Boron-containing | 13 | — | 2.0 |
| paper | | chemical | | | |

Experiment 3. Evaluation of Flammability

The sheets 1 to 4 obtained in Experiment 2 were evaluated for their flammability by the following procedure according to JIS A 1322 (JIS Z 2150). First, each sample was dried at 50° C. for 48 hours, and then left in a desiccator containing a silica gel desiccant for 24 hours and subjected to the following flammability test.

Each sample was mounted in a supporting frame (25 cm×16 cm) and tightly held in a flammability tester. After a gas burner was ignited, the sample was heated for 10 seconds or 1 minute, and determined for char length, after-flame time, and afterglow time (FIG. 11).

For the flammability test, a 45 degree flammability tester (FL-45M from Suga Test Instruments Co., Ltd.) was used. A Meker burner (height 160 mm, inside diameter 20 mm) was used for heating, and supplied with a gas alone without being mixed with the primary air. The fuel used was liquefied petroleum gas No. 5 (mainly composed of butane and butylene as defined in JIS K 2240), and the length of flame was adjusted to 65 mm before the sample was held.

Then, the heated test specimen was evaluated according to the provisions of JIS A 1322 (JIS Z 2150).
Char length: Measure the maximum longitudinal distance of the supporting frame corresponding to the charred area (i.e. the area showing evident changes in strength by charring) of the test specimen on the heated side.
After-flame time: Measure the length of time during which the test specimen continues to burn with flame after the end of heating.
After-glow: Refers to the state in which the specimen burns without flame after the end of heating.
Flame resistance rating on flame retardancy
Flame resistance rating 1: Char length of 5 cm or less, no after-flame, and no after-glow after 1 minute
Flame resistance rating 2: Char length of 10 cm or less, no after-flame, and no after-glow after 1 minute
Flame resistance rating 3: Char length of 15 cm or less, no after-flame, and no after-glow after 1 minute

The evaluation results are shown in the tables below, demonstrating that all of the chemically treated samples had a char length of 5 to 10 cm and exhibited a performance corresponding to flame resistance rating 2 as defined in JIS, though the chemically untreated sheets failed the JIS criteria (flame resistance rating 3). This suggested that a certain level of flame resistance can also be conferred on complex fiber sheets by chemical treatment.

TABLE 3-1

| | Substrate | | | |
|---|---|---|---|---|
| | Filter | | | |
| | paper | Sheet 1 | Sheet 2 | Sheet 3 |
| Chemical treatment | No | No | No | No |
| Basis weight of the | 100 | 160 | 100 | 100 |
| sheet [g/m²] | | | | |
| Type of inorganic | — | Ba sulfate | Mg carbonate | Hydrotalcite |
| particles | | | | |
| Inorganic fraction in | 0 | 64 | 43 | 33 |
| the sheet [%] | | | | |
| Char length [cm] | ∞ | ∞ | ∞ | ∞ |
| JIS criteria | Failed | Failed | Failed | Failed |

TABLE 3-2

| | Substrate | | | |
|---|---|---|---|---|
| | Filter | | | |
| | paper | Sheet 1 | Sheet 2 | Sheet 3 |
| Chemical treatment | Yes | Yes | Yes | Yes |
| Type of chemical | Boron- | Boron- | Boron- | Boron- |
| | based | based | based | based |
| | chemical | chemical | chemical | chemical |
| Basis weight of the | 100 | 160 | 100 | 100 |
| sheet [g/m²] | | | | |
| Type of inorganic | None | Ba | Mg | Hydro- |
| particles | | sulfate | carbonate | talcite |
| Inorganic fraction in | 0 | 64 | 43 | 33 |
| the sheet [%] | | | | |
| Sheet weight after | 6.87 | 13.92 | 13.92 | 20.48 |
| chemical treatment [g] | | | | |
| Chemical content | 26 | 14 | 14 | 20 |
| [g/m²] | | | | |
| Char length [cm] | 5.1 | 5.4 | 6.1 | 5.3 |
| JIS criteria | Flame | Flame | Flame | Flame |
| | resistance | resistance | resistance | resistance |
| | rating 2 | rating 2 | rating 2 | rating 2 |

TABLE 3-3

| | Substrate | | |
|---|---|---|---|
| | Filter | | |
| | paper | Sheet 1 | Sheet 2 |
| Chemical treatment | Yes | Yes | Yes |
| Type of chemical | Silicon- | Silicon- | Silicon- |
| | based | based | based |
| | chemical | chemical | chemical |
| Basis weight of the | 100 | 170 | 100 |
| sheet [g/m²] | | | |
| Type of inorganic | None | Ba sulfate | Mg carbonate |
| particles | | | |
| Inorganic fraction in | 0 | 64 | 43 |
| the sheet [%] | | | |
| Sheet weight after | 40.32 | 27.36 | 23.68 |
| chemical treatment [g] | | | |
| Chemical content | 40 | 27 | 24 |
| [g/m²] | | | |
| Char length [cm] | 9.5 | 6.9 | 7.4 |
| JIS criteria | Flame | Flame | Flame |
| | resistance | resistance | resistance |
| | rating 2 | rating 2 | rating 2 |

Further, the sheets 5 and 6 obtained in Experiment 2 were evaluated for their flammability by the following procedure. First, each sample was dried at 70° C. for 3 hours, and then left in a desiccator containing a silica gel desiccant for 2 hours and subjected to the following flammability test. Each sample was suspended by a clip attached to the upper end thereof. An ignited lighter (adjusted to a flame length of 30 mm before it came into contact with the sample) was quickly brought close to the lower end of the sample, and kept at a position where 10 mm of the flame was in contact with the sample to continuously heat it for 5 seconds (FIG. 12). During then, the spread of fire was observed.

The evaluation results are shown in the tables below, demonstrating that the chemically untreated sheets burned with a strong flame and the test specimens of all such samples were mostly lost, while the chemically treated filter paper caught a little flame during heating, but burned without flame and self-extinguished in about 3 seconds. However, the samples of the chemically treated complex fiber sheets were not observed to catch a flame and burn without flame, but they were only charred at the heated parts and the charred area was small. This experiment also suggested that a certain level of flame resistance can be conferred on complex fiber sheets by chemical treatment.

TABLE 3-4

| | Substrate | | |
|---|---|---|---|
| | Filter | | |
| | paper | Sheet 5 | Sheet 6 |
| Chemical treatment | No | No | No |
| Basis weight of the sheet | 105 | 135 | 135 |
| [g/m²] | | | |
| Type of inorganic particles | None | Silica/ | Ca carbonate |
| | | alumina | |
| Inorganic fraction in the | 0 | 18 | 56 |
| sheet [%] | | | |

Substrate

| | Filter | |
|---|---|---|
| | paper | Sheet 5 |
| Chemical treatment | Yes | Yes |
| Type of chemical | Phosphorus/ | Phosphorus/ |
| | nitrogen- | nitrogen- |
| | based chemical | based chemical |
| Basis weight of the sheet | 105 | 135 |
| [g/m²] | | |
| Type of inorganic particles | None | Silica/ |
| | | alumina |
| Inorganic fraction in the | 0 | 18 |
| sheet [%] | | |
| Sheet weight after chemical | 1.206 | 1.675 |
| treatment [g] | | |
| Chemical content [g/m²] | 85 | 102 |

| | Substrate | | |
|---|---|---|---|
| | Filter | | |
| | paper | Sheet 5 | Sheet 6 |
| Chemical treatment | Yes | Yes | Yes |
| Type of chemical | Boron- | Boron- | Boron- |
| | containing | containing | containing |
| | chemical | chemical | chemical |
| Basis weight of the sheet | 103 | 137 | 134 |
| [g/m²] | | | |
| Type of inorganic particles | None | Silica/ | Ca carbonate |
| | | alumina | |
| Inorganic fraction in the | 0 | 18 | 56 |
| sheet [%] | | | |
| Sheet weight after chemical | 0.753 | 1.112 | 1.054 |
| treatment [g] | | | |
| Chemical content [g/m²] | 16 | 19 | 14 |

Experiment 4. Evaluation of Inkjet (IJ) Printability Using an U printer (Canon PIXUS iP7100, dye-based ink), a pattern was printed, and the U printability of samples was evaluated before and after chemical treatment.

Specifically, the IJ printability of each sample was evaluated for the ink bleeding and color reproduction of the IJ printed pattern by visual observation and scored on a 5-point rating scale from 1 to 5. Higher values indicate better printability, and the printability of a chemically untreated commercially available IJ printing paper corresponds to “5”. (Ink bleeding) Excellent 5 (untreated U printing paper)→1 Poor (Color reproduction) Excellent 5 (untreated IJ printing paper)→1 Poor

The evaluation results are shown in the tables below, demonstrating that the printability of conventional papers (copy paper, IJ printing paper, filter paper) considerably declined after they were treated with any flame retardant, but complex fiber sheets (sheets 1, 2, 4, 5) treated with any flame retardant could be printed on in the same manner as before chemical treatment. Especially, the bleeding resistance and color reproduction of sheets 4 and 5 were excellent after chemical treatment.

The foregoing results showed that the worsening of ink bleeding by chemical treatment can be reduced and excellent printing quality can be provided.

TABLE 4

| | Inorganic | | Chemical | | | | | |
|---|---|---|---|---|---|---|---|---|
| | fraction | | content | Inorganic | Ink bleeding | | Color reproduction | |
| | in the | | [% vs | material | Before | After | Before | After |
| Substrate | sheet [%] | Type of chemical | total] | complexed | treatment | treatment | treatment | treatment |
| Sheet 1 | 64 | Boron-based | 8 | Ba sulfate | 4 | 4 | 3 | 2 |
| | | chemical | | | | | | |
| Sheet 2 | 43 | Boron-based | 12 | Mg carbonate | 3 | 3 | 2 | 1 |
| | | chemical | | | | | | |
| Sheet 4 | 61 | Boron-based | 8 | Hydrotalcite | 5 | 4 | 4 | 4 |
| | | chemical | | | | | | |
| Sheet 5 | 18 | Phosphorus/nitrogen- | 43 | Silica/alumina | 4 | 3 | 4 | 4 |
| | | based chemical | | | | | | |
| | | Boron-containing | 12 | Silica/alumina | 4 | 4 | 4 | 4 |
| | | chemical | | | | | | |
| Sheet 6 | 56 | Boron-containing | 9 | Calcium | 4 | 3 | 4 | 3 |
| | | chemical | | carbonate | | | | |
| Filter | 0 | Phosphorus/nitrogen- | 45 | — | 2 | 2 | 3 | 2 |
| paper | | based chemical | | | | | | |
| Filter | 0 | Boron-containing | 13 | — | 2 | 1 | 3 | 2 |
| paper | | chemical | | | | | | |
| PPC | 5 | Boron-based | 12 | — | 3 | 2 | 4 | 3 |
| paper | | chemical | | | | | | |
| IJ paper | 26 | Boron-based | 11 | — | (5) | 3 | (5) | 4 |
| | | chemical | | | | | | |

Experiment 5. Preparation and Evaluation of Complex Fiber Boards

### <Preparation of Molded Products Using Complex Fibers>

Molded products for use in a heat release test were prepared by the following procedure. Chemical solution A (a boron-based chemical available as a 36 wt % aqueous solution under the brand name BestBoron from Soufa Inc.) was used for the board samples below.

(Board 1)

An aqueous suspension of Sample 1 was cast into a mold with a mesh bottom (144 mm×144 mm×100 mm) and compression molded to prepare a board. This was pressed at 1 MPa for 1 minute, then at 3 MPa for 2 minutes, and then dried using an incubator set at 75° C. for 10 hours. The resulting dry sample was cut into a 100 mm cube, which was immersed in chemical solution A shown above at 75° C. for 60 minutes and then dried using an incubator set at 105° C. for 5 hours to prepare board 1.

(Board 2)

A square prism mold with a mesh bottom (144 mm×144 mm×10 cm) was attached to the cleaning end of a liquid vacuum cleaner and immersed in a resin vessel (having an internal volume of 25 L) containing a mixed aqueous suspension of an aqueous suspension of Sample 6 and calcium carbonate (JIS special grade from KANTO CHEMICAL CO., INC.), and immediately after then, suction was started. After about 10 seconds of suction, the mold was lifted and suction was continued for 30 seconds. After the completion of suction, the cast was removed from the mold and pressed (at 1 MPa for 1 minute, then at 3 MPa for 2 minutes) and then dried using an incubator set at 75° C. for 10 hours. The resulting dry sample was cut into a 100 mm cube, which was immersed in chemical solution A shown above at 75° C. for 60 minutes and then dried using an incubator set at 105° C. for 5 hours to prepare board 2.

(Board 3)

Board 3 was prepared by the same procedure as described above for board 2 except that a mixed aqueous suspension of an aqueous suspension of Sample 6 and Mitsuishi pagodite (from Takeshou Seiko Co., Ltd.) was used.

<Evaluation of the Complex Fiber Boards>

According to ISO 5660-1: 2002, the total heat released for 20 minutes as measured by the cone calorimeter method and the size shrinkage after testing were evaluated. Materials satisfying the following three criteria can be judged to correspond to “noncombustible materials” defined in the Building Code of Japan. It should be noted that when “the shrinkage of a sample after heating was more than 5 mm”, the sample was evaluated as having suffered a “detrimental deformation”.

(Evaluation Criteria)
The total heat released shall be 8 MJ/m² or less.
Any detrimental deformation or penetrating crack and hole shall not have occurred (as evaluated on the basis of the appearance and the shrinkage of the sample after heating).
The maximum heat release rate shall not exceed 200 kW/m² continually for 10 seconds or more

The results of the evaluation made according to the evaluation criteria defined above are shown in the table below, demonstrating that all of the chemically treated boards 1 to 3 satisfied all of the evaluation criteria. This suggested that they have fire-protective properties corresponding to those of non-combustible materials.

The foregoing results showed that when boards are prepared by using a complex fiber sheet treated with a flame retardant chemical solution as a substrate, they can exhibit fire-protective properties corresponding to those of non-combustible materials defined in the Building Code of Japan.

Further, boards representing a raised and recessed pattern could be obtained by using a patterned mold during molding.

TABLE 5

| Sample | Board 1 | Board 2 | Board 3 |
|---|---|---|---|
| Chemical used | Boron-based chemical | | |
| Mass of the board [g] | 123.95 | 23.83 | 24.91 |
| Thickness of the board [mm] | 9.7 | 2.8 | 3.4 |
| Solids amount of the chemical [g] | 27.94 | 6.68 | 8.80 |
| Total heat released [MJ/m²] | 5.7 | 4.3 | 1.4 |
| Penetrating crack and hole | None | None | None |
| Shrinkage [mm] | 2 | 2 | 0 |
| Time during which the heat release rate | 0 | 0 | 0 |
| continually exceeds 200 kW/m² [s] | | | |
| Evaluation | Pass the | Pass the | Pass the |
| | criteria | criteria | criteria |

1. A complex fiber of inorganic particles and a fiber treated with a flame retardant, wherein 15% or more of the surface of the fiber is covered by the inorganic particles.

2. The complex fiber of claim 1, wherein the flame retardant is a boron-based flame retardant or a silicon-based flame retardant.

3. The complex fiber of claim 2, wherein the fiber is a cellulose fiber.

4. The complex fiber of claim 2, wherein the inorganic particles are inorganic particles of at least one member selected from the group consisting of barium sulfate, magnesium carbonate and hydrotalcite.

5. The complex fiber of claim 4, wherein the inorganic particles have an average primary particle size of 1.5 μm or less.

6. The complex fiber of claim 5, wherein the weight ratio between the fiber and the inorganic particles is 5/95 to 95/5.

7. The complex fiber of claim 6, which is in the form of a sheet, molding, board or block.

8. The complex fiber of claim 7, wherein the flame retardant is a phosphorus-based chemical and/or a nitrogen-based chemical.

9. The complex fiber of claim 8, wherein the inorganic particles comprise calcium carbonate or silica/alumina.

10. A process for preparing the complex fiber of claim 1, comprising treating a complex fiber of inorganic particles and a fiber with a flame retardant.

11. The process of claim 10, comprising treating the complex fiber by impregnating, coating or spraying it with a flame retardant.

12. The process of claim 10, comprising synthesizing the inorganic particles in a solution containing the fiber to give the complex fiber.

13. The complex fiber of claim 1, wherein the fiber is a cellulose fiber.

14. The complex fiber of claim 1, wherein the inorganic particles are inorganic particles of at least one member selected from the group consisting of barium sulfate, magnesium carbonate and hydrotalcite.

15. The complex fiber of claim 1, wherein the inorganic particles have an average primary particle size of 1.5 μm or less.

16. The complex fiber of claim 1, wherein the weight ratio between the fiber and the inorganic particles is 5/95 to 95/5.

17. The complex fiber of claim 1, which is in the form of a sheet, molding, board or block.

18. The complex fiber of claim 1, wherein the flame retardant is a phosphorus-based chemical and/or a nitrogen-based chemical.

19. The complex fiber of claim 1, wherein the inorganic particles comprise calcium carbonate or silica/alumina.
